(19) United States
(12) Patent Application Publication
(10) Pub. No.: US 2002/0121170 A1
(43) Pub. Date: Sep. 5, 2002

(54) Log saw diverter

(75) Inventors: Anthony Mark Gambaro, Appleton, WI (US); Robert Eugene Krautkramer, Kaukauna, WI (US); Mark Edward Mertz, Greenville, WI (US); James Monroe Perkins, Appleton, WI (US); Thomas Paul Prillwitz, Greenville, WI (US); James Bennington Stopher, Pocatello, ID (US)

Correspondence Address: BRINKS HOFER GILSON & LIONE, P.O. BOX 10395, CHICAGO, IL, 60610, US

(73) Assignee: Kimberly Clark Worldwide, Inc.

(21) Appl. No.: 10/003,454

(22) Filed: Oct. 31, 2001

Related U.S. Application Data
(63) Continuation of application No. 09/747,594, filed on Dec. 22, 2000.

(51) Int. Cl. B26D 7/06

(52) U.S. Cl. 83/154; 83/167

(57) ABSTRACT

There is provided an apparatus for dividing logs of substrate into rolls and a method of using this apparatus. The apparatus may include a distribution sprocket, a pocket for holding the log, a cutting device, and a device for collecting the rolls. Logs may be transported, divided, and distributed without the need for secondary clamping devices.

### BACKGROUND OF THE INVENTION

Wet products such as wet wipes have many applications. They may be used with small children and infants when changing diapers, they may be used for house hold cleaning tasks, they may be used for cleaning hands, they may be used as a bath tissue, they may be used as by a caregiver to clean a disabled or incontinent adult, or they may be used in and for a whole host of other applications, where it is advantages to have a wipe or towel that has some moisture in it.

Wet wipes have been traditionally been made in processes in which larger webs of wipes are initially made and than these larger webs are converted into smaller rolls or sheets that can be placed in a dispenser. Examples of such dispensers are disclosed in pending U.S. application entitled System and Dispenser for Dispensing Wet Wipes, Serial No. 09/565,227 filed May 4, 2000; pending U.S. application entitled Wipes Dispensing System, Ser. No. 09/659,295, filed Sep. 12, 2000; and pending U.S. application entitled Mounting System for a Wet Wipes Dispenser, Ser. No. 09/659,307, filed Sep. 12, 2000, the disclosures of which are incorporated herein by reference.

Wet wipes can be any wipe, towel tissue or sheet like product including natural fibers, synthetic fibers, synthetic material and combinations thereof, that is wet or moist. Examples of wet wipes are disclosed in application Ser. Nos. 09/564,449; 09/564,213; 09/565,125; 09/564,837; 09/564,939; 09/564,531; 09/564,268; 09/564,424; 09/564,780; 09/564,212; 09/565,623 all filed May 4, 2000, and application Ser. No. 09/223,999 entitled Ion-Sensitive Hard Water Dispersible Polymers And Applications Therefore, filed Dec. 31, 1998 the disclosures of which are incorporated herein by reference.

### BRIEF SUMMARY OF THE INVENTION

In an embodiment of the invention there is provided a continuous method of cutting a plurality of moist substrates comprising: a) placing a log of moist substrate on a conveyor, the log having a length, a width and a moisture content of at least about 50%; b) advancing the conveyor; c) discharging the log from the conveyor onto a transfer plate; d) placing the log into a pocket on a cutting support; e) advancing the pocket containing the log toward a plurality of cutting blades; f) advancing the pocket containing the log through the cutting blades, whereby the log is cut into a number of shorter rolls; g) advancing the pocket containing the rolls away from the cutting blades; h) discharging the rolls from the pocket; and, repeating steps a) through h) in a continuous manner. The log may be at least 2540 mm long and may have a diameter of from about 50 mm to about 140 mm. At least 95% of the log may be cut into useable rolls.

In a further embodiment of the present invention, there is provided a method of cutting a coreless wet wipes log comprising: a) placing a coreless wet wipes log in a pocket, the log having a length of at least 2540 mm, a diameter of from about 50 mm to about 140 mm and a moisture content of at least 50% b) advancing the pocket containing the log toward a cutting position; c) cutting the log into a plurality of rolls in the cutting position; d) the pocket maintaining the shape, integrity and position of the log as it is cut into rolls without the need for clamps and with out the need for a mandrel; and, e) discharging the rolls from the pocket.

These embodiments may further comprise repeating steps a) through e) in a continuous process resulting in the production of at least 300 rolls per minute; using a conveyor is to place the logs in the pockets; discharging the rolls into a diverter; and cutting at least 95% of the log into useable rolls.

In a further embodiment of the present invention, there is provided a method of making a plurality of wet wipes rolls comprising: a) placing a wet wipes log on a conveyor, the log having a length, a width and a moisture content of at least about 65%; b) advancing the conveyor; c) discharging the log from the conveyor into a holding support; d) advancing the support containing the log toward a plurality of cutting blades; e) engaging the log and the cutting blades, whereby the log is sectioned into a plurality of rolls; and, repeating steps a) through e) so that at least 300 rolls are produced per minute. The log may be at least 2540 mm long and may have a diameter of from about 50 mm to about 250 mm. At least 95% of the log may be cut into useable rolls.

In a further embodiment of the present invention, there is provided a continuous method of cutting a plurality of wet wipes logs comprising: a) placing a coreless wet wipes log on a conveyor, the log having a length, a width and a moisture content of at least about 50%; b) advancing the conveyor; c) discharging the log from the conveyor onto a transfer plate; d) metering the rate at which the log is discharged from the transfer plate to a pocket; e) advancing the pocket containing the log toward a plurality of cutting blades; f) engaging the log in the pocket with the cutting blades, whereby the log is cut into a number of shorter rolls; g) discharging the rolls from the pocket; h) repeating steps a) through g) in a continuous manner; and, periodically interrupting the repetition of steps a) through g) to move the cutting blades to a position away from pocket; and, honing the cutting blades while in the away position, whereby material from the honing does not contaminate the pocket, the log, or the rolls. The log may be at least 2540 mm long and may have a diameter of from about 50 mm to about 140 mm. At least 95% of the log may be cut into useable rolls.

In a further embodiment of the present invention, there is provided a cutting apparatus comprising: a base; a plurality of pockets; a drive; and a saw; the plurality of pockets arranged in an endless loop; the drive associated with the pockets; the saw associated with the pockets; the pockets having channels therein; the saw having a cutting surface; the cutting surface being capable of being positioned within a channel; the pockets having a front side, a bottom and a back side; the front side having a lip; and the back side having a flat surface.

These embodiments may further comprise a saw which comprises at least 10 blades; at least 4 pockets; and pockets having a distance between the front side and back side, the distance being from about 50 mm to about 250 mm.

In a further embodiment of the present invention, there is provided a cutting apparatus comprising: a base; a sprocket; a plurality of pockets spaced around the sprocket; a drive; and a saw; the drive associated with the sprocket; the saw associated with the sprocket; the pockets having a plurality of channels therein; the saw having a plurality of blades; the blades capable of being positioned within the channels; the pockets having a front side, a bottom and a back side; the front side having an arcuate lip; the front side having an flat surface; the bottom side having an arcuate surface; and the back side having a flat surface; the front and bottom surface forming a support surface that maintains the shape and form of the object during cuffing. The saw may further comprise at least 10 blades; the apparatus may comprise at least 4 pockets; and the width of the pockets is from about 50 mm to about 150 mm.

In a further embodiment of the present invention, there is provided a system for making rolls of wipes, the system comprising: a first metering device; a first transporting device; a second metering device; a second transporting device; a cutting device; a holding device; and a third transporting device; the first metering device associated with the first transporting device; the second metering device associated with both the first transporting device and the second transporting device; the second transporting device associated with the holding device; the cutting device associated with the second transporting device; the third transporting device associated with the second transporting device; the first metering device comprising a first controller and a first gate; the first transporting device comprising a first drive, a second controller, a base, a frame and a plurality of pockets; the second metering device comprising a third controller and a second gate; the third transporting device comprising a second drive, a fourth controller, a diverting device, and a holding device; and, the cutting device comprising a plurality of blades, a third drive, and a fifth controller. The controllers may all be the same; there may be a master controller, the master controller associated with the controllers; the cutting device may comprise at least 10 stainless steel blades; and there may be a honing device associated with the cutting device.

In a further embodiment of the present invention, there is provided a method of cuffing a plurality of flexible substrates comprising: a) placing a flexible log on a conveyor, the log having a length and a width; b) advancing the conveyor; c) discharging the log from the conveyor into a holding support; d) advancing the support containing the log toward a plurality of cutting blades; e) engaging the log and the cuffing blades, whereby the log is sectioned into a plurality of rolls; and, repeating steps a) through e) so that at least 300 rolls are produced per minute. The log may be at least 2540 mm long and may have a diameter of from about 50 mm to about 250 mm. At least 95% of the log may be cut into useable rolls.

In a further embodiment of the present invention, there is provided a continuous method of cutting a plurality of flexible logs comprising: a) placing a flexible log on a conveyor, the log having a length and a width; b) advancing the conveyor; c) discharging the log from the conveyor onto a transfer plate; d) metering the rate at which the log is discharged from the transfer plate to a pocket; e) advancing the pocket containing the log toward a plurality of cutting blades; f) engaging the log in the pocket with the cutting blades, whereby the log is cut into a number of shorter rolls; g) discharging the rolls from the pocket; h) repeating steps a) through g) in a continuous manner; and, periodically interrupting the repetition of steps a) through g) to move the cutting blades to a position away from pocket; and, honing the cutting blades while in the away position, whereby material from the honing does not contaminate the pocket, the log, or the rolls. The log may be at least 2540 mm long and may have a diameter of from about 50 mm to about 140 mm. At least 95% of the log may be cut into useable rolls.

In a further embodiment of the present invention, there is provided a continuous method of cuffing a plurality of substrates comprising: a) placing a log of substrate on a conveyor, the log having a length and a width; b) advancing the conveyor; c) discharging the log from the conveyor onto a transfer plate; d) placing the log into a pocket on a cutting support; e) rotating the pocket containing the log toward a plurality of circular cutting blades; f) rotating the pocket containing the log through the circular cutting blades, whereby the log is cut into a number of shorter rolls; g) rotating the pocket containing the rolls away from the cutting blades; h) discharging the rolls from the pocket; and, repeating steps a) through h) in a continuous manner.

### BRIEF DESCRIPTION OF SEVERAL VIEWS OF THE DRAWINGS

FIG. 1 is a side view of an apparatus.

FIG. 2 is a detail side view of the apparatus of FIG. 1.

FIG. 3 is a partial perspective view of an apparatus.

FIG. 4 is a view of a pocket.

FIG. 5 is a side view of an apparatus.

FIG. 6 is a side view of an apparatus.

FIG. 7 is a side view of an apparatus.

FIG. 8 is a side view of a conveyor.

FIG. 9 is a side cross-sectional view of a conveyor.

FIG. 10 is a frame view of a conveyor.

FIG. 11 is a diagram of the forces applied to a log.

FIG. 12 is an operator side view of a sprocket.

FIG. 13 is a drive side view of a sprocket.

FIG. 14 is a front partial section view of a sprocket.

FIG. 15 is a side view of a cutting assembly.

FIG. 16 is a front view of a cutting assembly.

FIG. 17 is a front view of one set of blades.

FIGS. 18-19 are side views of a blade.

FIGS. 20-21 are views of a bearing block.

FIGS. 22-25 are views of blade couplings.

FIG. 26 is a side view of a honing assembly.

FIG. 27 is a front view of a frame for a honing assembly.

FIG. 28 is a section view of a frame for a honing assembly.

FIG. 29 is a back view of a section of a honing assembly.

FIG. 30 is a top view of a honing assembly.

FIG. 31 is a side view of a set of hones.

FIG. 32 is a front view of a set of hones.

FIG. 33 is a top view of a diverter.

FIG. 34 is an end view of a diverter.

FIG. 35 is a side view of a diverter.

FIGS. 36-38 are schematic views of a saw and a sprocket.

FIGS. 39-40 are side views of a sprocket, diverter, and index conveyors.

### DETAILED DESCRIPTION OF THE INVENTION

An apparatus for cutting a substrate into individual rolls is provided which in general provides for cutting low rigidity substrate logs, such as moistened logs, into rolls. The use of this apparatus minimizes distortion of the finished product, especially in terms of shape and cut squareness. This apparatus can be used to process moistened product, and it provides a sanitary processing environment due to its reduced potential for microbial growth.

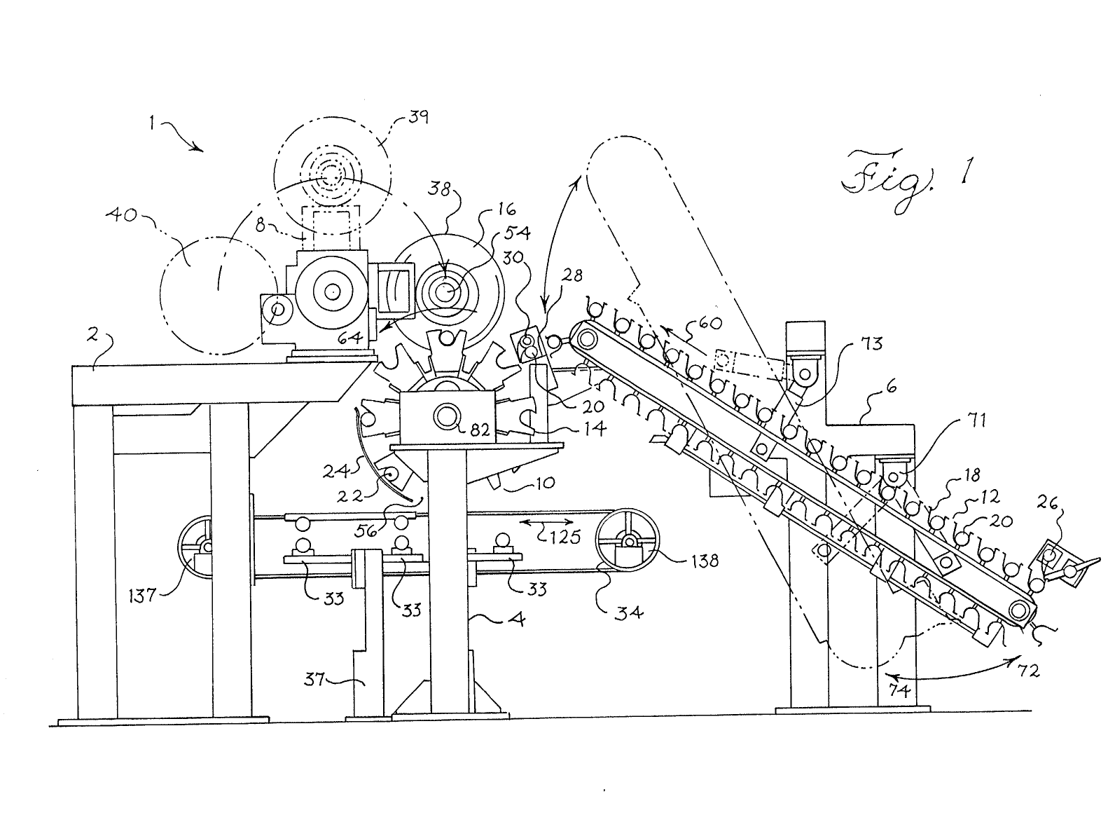

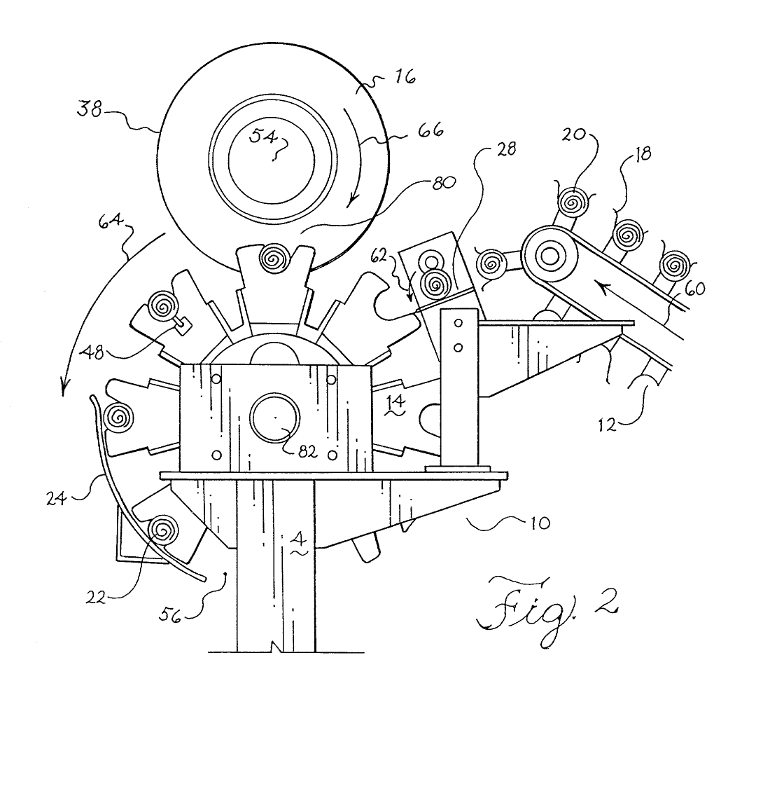

As shown in FIG. 1, there is provided in general an apparatus 1 that cuts an entire log 20 of substrate into individual rolls 22. Logs are delivered into a distribution sprocket 10 and are transported in a direction perpendicular to the longitudinal axis of the log. The pockets 14 in the distribution sprocket are shaped to hold logs during the cutting operation without the need to use a secondary clamping device. A log which is nested into the sprocket is supported along its entire length and rotated into a cutting area 80 (FIG. 2) where it is divided into rolls by a cutting device, such as a multi-blade rotary saw 8 having a common axis 54. The divided log is rotated past the cutting area, and the individual rolls are secured in the pockets by a roll retention device 24. The retention device prevents the rolls from leaving the pockets until the desired roll exit point 56 is reached. Unwinding and scuffing of the rolls is also prevented by the retention device. The rolls may be deposited on a diverter 34 which then delivers the rolls to an index conveyor 33 for further processing.

Substrates for which this apparatus is useful are any type of substantially cylindrical rolls or logs. For example, the substrate could be a solid cylinder of material, a hollow cylinder such as a pipe or tube, or a wound roll of a web. The apparatus is particularly useful for wound rolls having low rigidity, for example moistened logs such as would be used as precursors for rolls of wet wipes. The low rigidity substrate may be other soft or flexible logs such as foams, sponge-like materials, food products, etc. For example, the substrate may be a log of a cheese product or meat product. Also, the substrate may be a dry roll of paper, such as tissue paper. Since the substrate is secured during the cutting procedure, there is no need for a spindle or mandrel to be used for roll products. Thus, coreless rolls of wet wipes can be cut precisely by this apparatus.

Examples of wet wipes rolls which may be produced by this apparatus include those described in the patent applications listed above. A log of wet wipes from which such rolls are cut may have a diameter between 50 mm and 140 mm, preferably between 75 mm and 120 mm, and more preferably about 73 mm. When unwound into a sheet, the length of the resulting sheet may be between 400 inches (10 m) to 1000 inches (25 m), preferably about 450 inches (11.5 m). The wound log has a length along its longitudinal axis between about 2540 mm to 3050 mm, preferably 2620 mm to 2920 mm, more preferably about 2690 mm. The wet wipes have a moisture content above 50 percent-by-weight (wt %), preferably above 65 wt %, more preferably about 69 wt %.

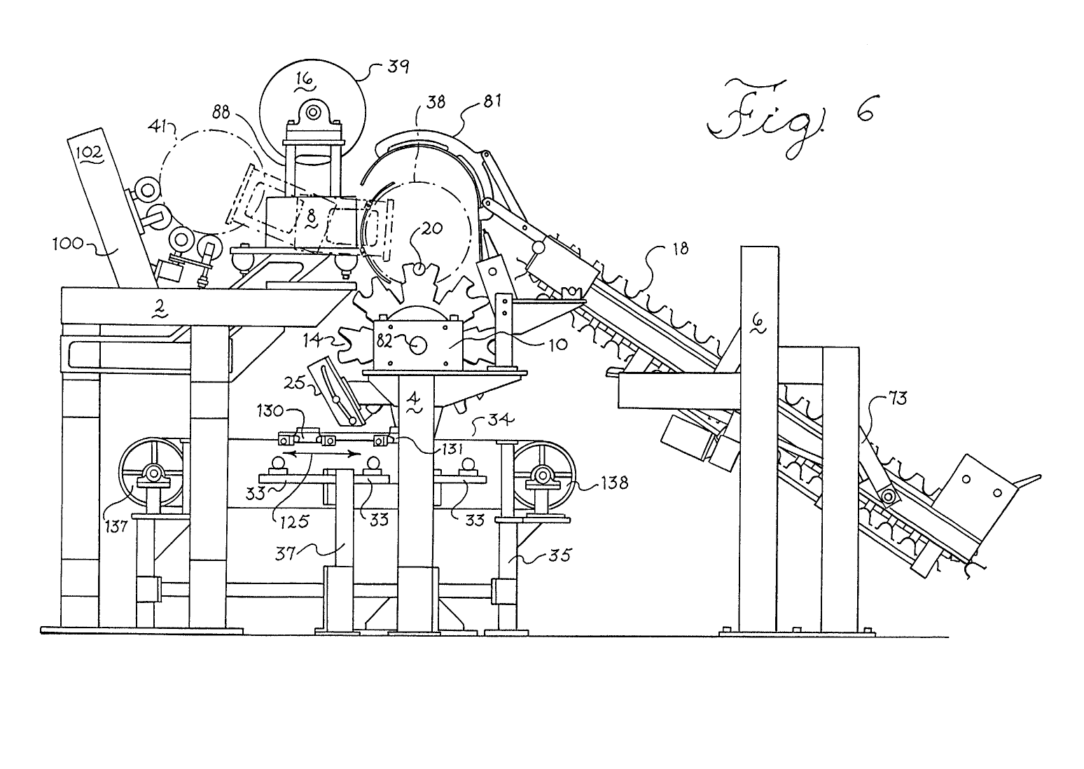

Referring to FIG. 1, the logs may be delivered initially to an infeed conveyor 12. The delivery may be metered if necessary, such as by a controllably movable gate 26. The conveyor is mounted on a frame 6. The conveyor is preferably made of 316L stainless steel. The conveyor may be movably mounted such that it can be in a lowered position 72 during use or can be in a raised position 74 for maintenance or cleaning. The conveyor may be mounted to the frame by support arms 73, which are connected to struts 69 and servo motors 71 (FIGS. 9-10). These support arms raise or lower the conveyor in response to a signal from an actuator.

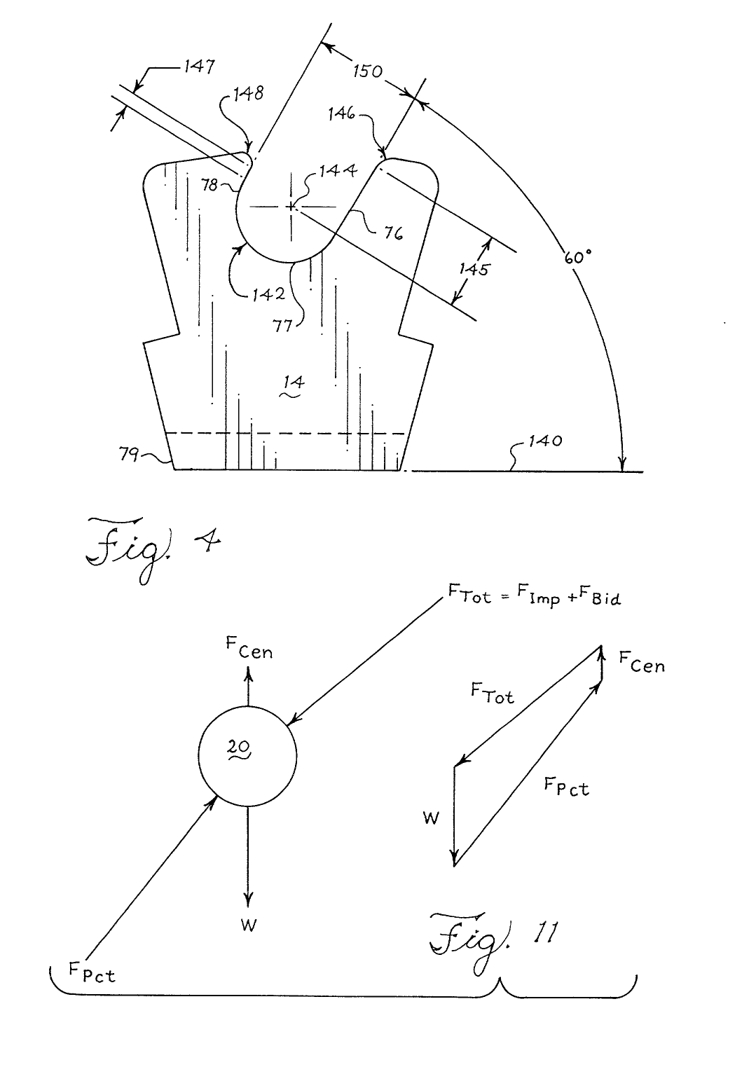

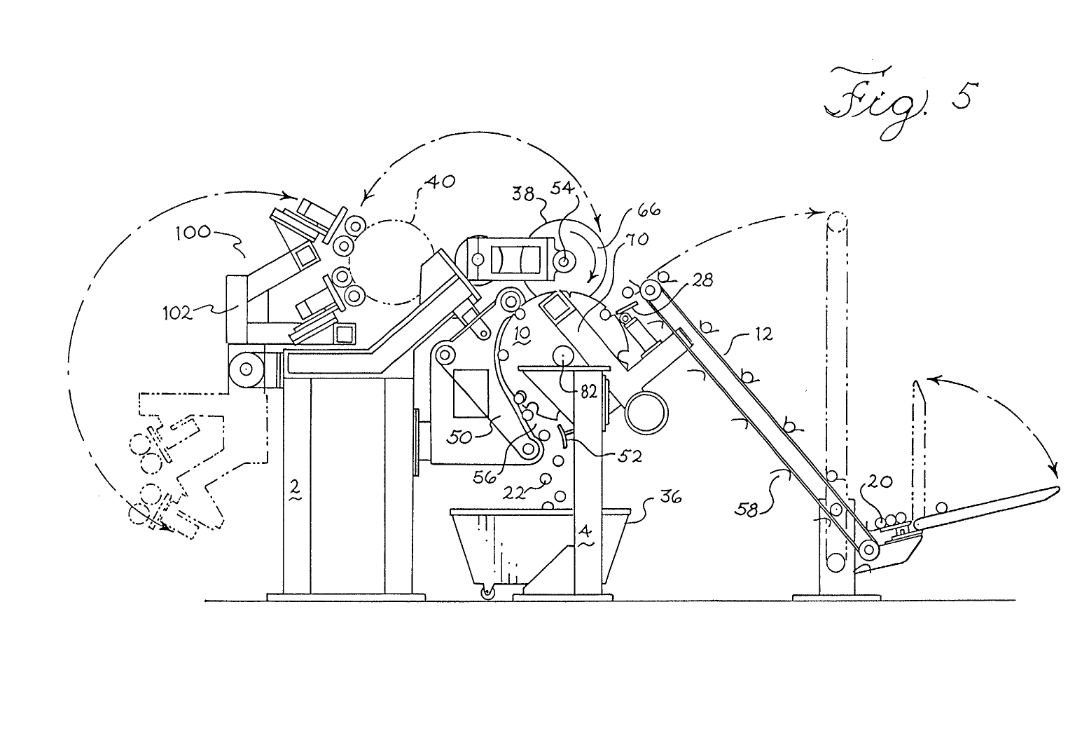

The infeed conveyor is equipped with concave holders 18 which cradle the logs and prevent them from falling off the conveyor. The holders are preferably shaped as shown in FIGS. 1 or 6 with planar walls and a curved bottom. This configuration allows the roll to be dropped into the holder in a vertical manner, rather than rolling in at an angle. The optional metering gate 26 can also assist in assuring this vertical delivery. Holders of different dimensions and configurations may be employed for different substrates. For example, holder 58 (FIG. 5) may have a curved bottom and a supporting wall. The holder may be a shelf 59 which is substantially perpendicular to the direction of motion of the conveyor, as shown in FIG. 7. The conveyor may be equipped to support a variety of interchangeable holders.

The logs may be delivered to the infeed conveyor in a consistent manner, such that the logs are in alignment with each other. It is preferred that the logs are also substantially aligned with respect to the log saw apparatus. Portions of the log that extend beyond the outermost saw blades may produce rolls which have dimensions and/or edges that are undesirable. If an end of the log does not extend to the outermost blade, the roll from that end may also have dimensions and/or edges that are undesirable. These rolls with non-optimal or inconsistent dimensions may then be treated as waste or may be recycled or put to other uses. It is preferred that a relatively small portion of the substrate log is cut from each end of the log by the outermost saw blades such that the inconsistent rolls account for less than 10%, preferably less than 5%, and preferably between about 1% and 3% of the total length of the log. Any logs that are out of alignment may be aligned manually as needed, although an automated alignment system could also be employed.

Moving in the direction of arrow 60, the infeed conveyor delivers the log to the distribution sprocket 10 by allowing the log to fall out of the holder onto a guide plate 28. The holders on the conveyor are supported by wear strips, which are preferably made of ultra-high molecular weight (UHMW) polyethylene. The rotation of the roll on the guide plate is in the direction of arrow 62 as illustrated in FIG. 2. This rotation is preferably such that, at the point of contact between the tail of the roll and the surface, the motion of the tail is opposite the overall motion of the roll itself. This inhibits any unwinding of the roll. This guide plate may be equipped with a controllably movable gate 30 (FIG. 1) to meter the delivery to the sprocket. Optionally, the infeed conveyor may allow the roll to fall directly into the pocket 14 in the distribution sprocket.

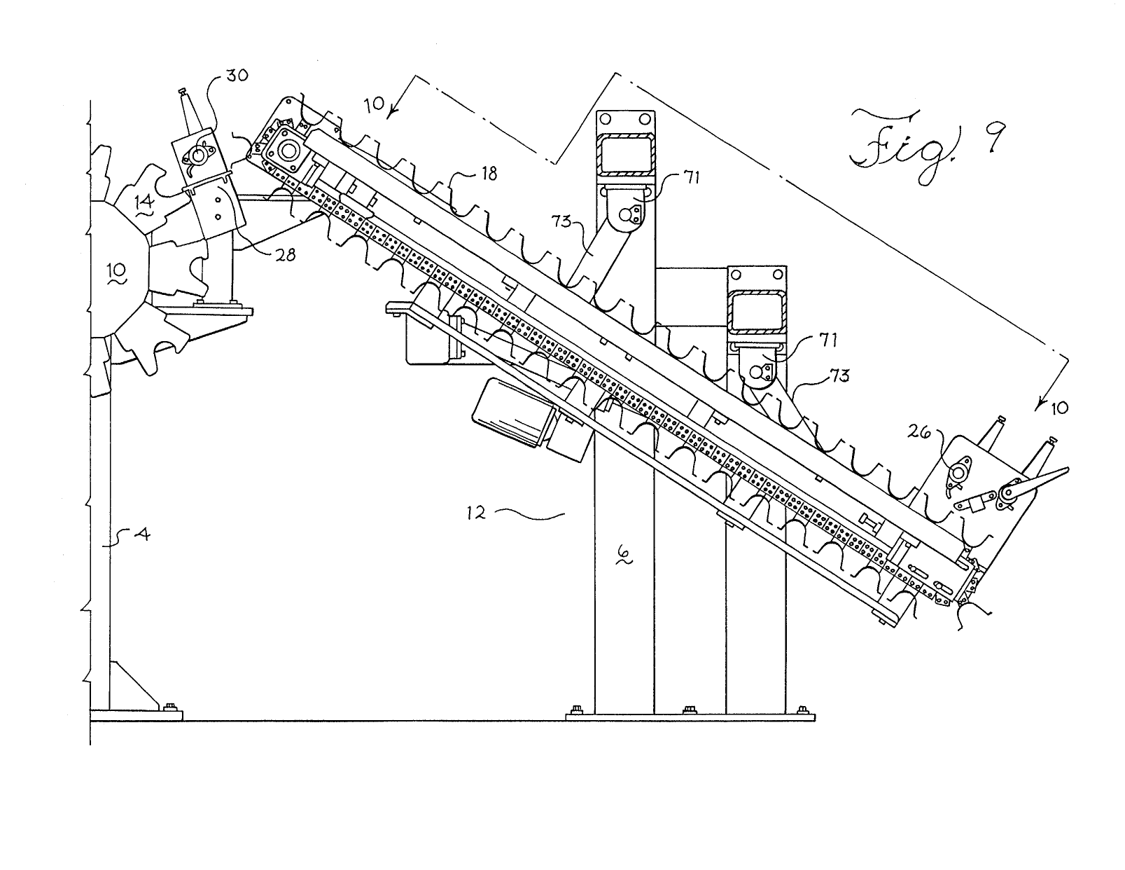

The distribution sprocket 10 rotates the log in the direction of arrow 64 into the cutting area 80. The rotation of the sprocket is preferably a continuous motion, although intermittent or stepwise movement may be employed. The sprocket rotates the divided roll away from the cutting area such that the individual rolls may be collected. The rolls may be dropped onto a diverter 34 (FIG. 1), into a receptacle or bin 36 (FIG. 5), or onto a conveyor 31 (FIG. 7). The rolls may also be ejected from the sprocket. The rolls may then be delivered for subsequent processing and/or packaging or may be tested to monitor product quality. The sprocket is mounted on a frame 4 and rotates on a rotating shaft 82 attached to servo motor 84 (Figure 14).

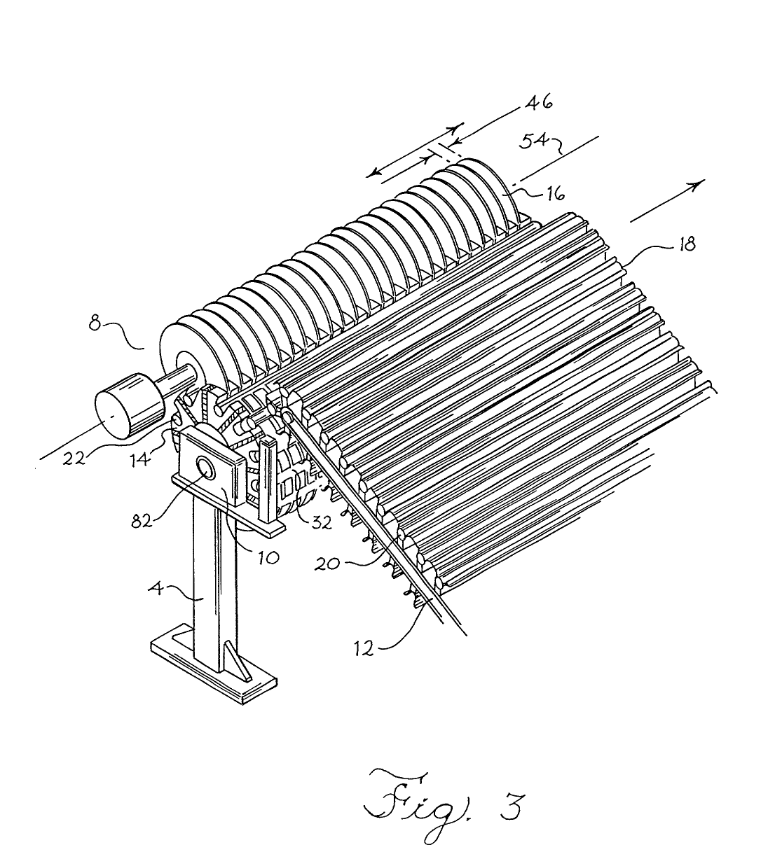

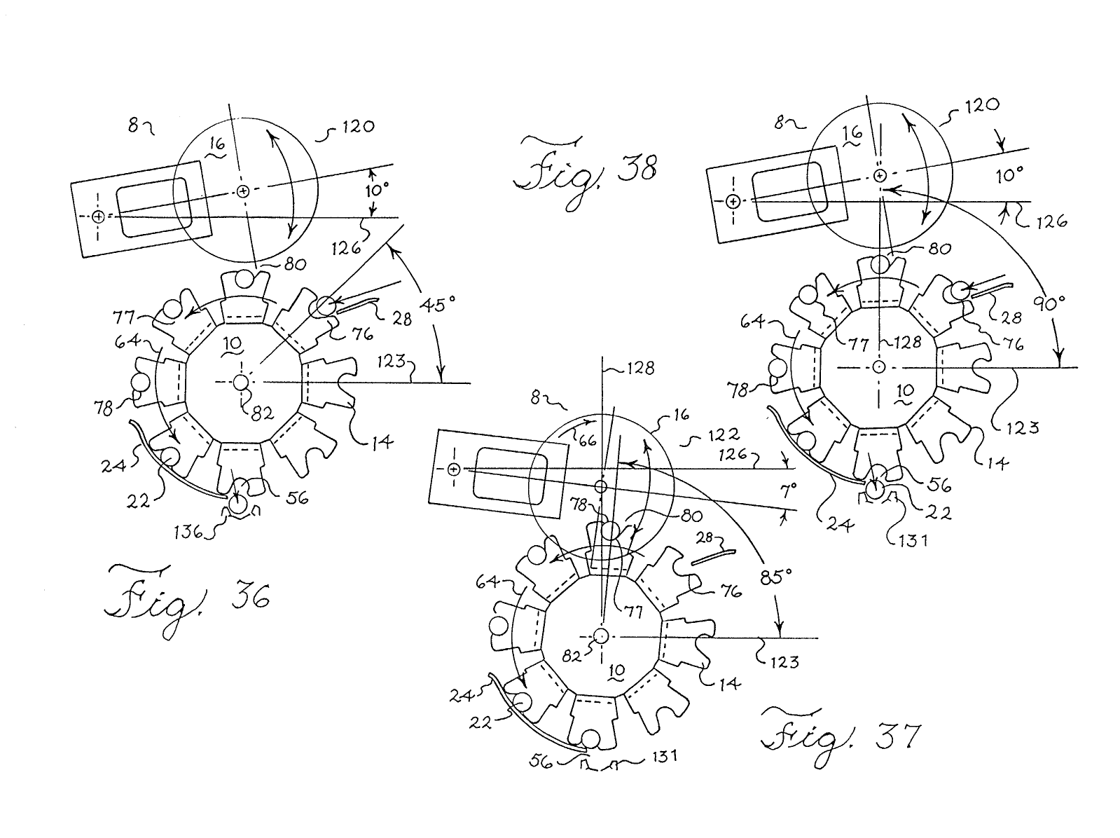

The sprocket has pockets 14 for delivering the log to the cutting area. In the embodiment shown in FIG. 4, the pocket has a base 79, planar portions 76 and 78, and a curved portion 77. The curved portion forms a closed end of the pocket, with an open end formed by the space between the planar portions. The planar walls 76 and 78 of the pocket are at an angle of 60-degrees from the horizontal axis 140, which is defined by the base of the pocket. The configuration in this embodiment provides for ease of delivery of the log into the pocket from the infeed conveyor 12 and also provides stability to the log during the cutting procedure. As shown in FIGS. 36 and 38, the log is preferably delivered to the sprocket when the receiving pocket is at an angle of 45-degrees from the horizontal axis 123. Other angles of delivery can be used, depending on the overall configuration of the apparatus. The log may be delivered when the receiving pocket is between 30-degrees and 80-degrees from the horizontal axis 123.

Pockets of different dimensions and configurations, as illustrated for example in FIG. 5, may be employed for different substrates or final products. The sprocket may be equipped to support a variety of interchangeable pockets. By way of example, a pocket 14 for use with a roll having a diameter of 73 mm has preferred dimensions. Curved portion 77 has a radius of curvature 142 of 1.50 inches (38.1 mm), and the radius has a center 144. Planar wall 76 has a width 145 of 2.06 inches (52.3 mm) and has a curved lip 146 at the open end with a radius of curvature of 0.50 inch (12.7 mm). Planar wall 78 has a width 147 of 0.38 inch (9.7 mm) and has a curved lip 148 at the open end with a radius of curvature of 0.25 inch (6.4 mm). The distance 150 between the planar portions is 3.00 inches (76.2 mm). Pockets 14 for use with logs that are larger or smaller than this can have different dimensions. For example, the radius of curvature 142 may be between 12 mm and 130 mm; wall 76 may have a width 145 less than 150 mm; wall 78 may have a width 147 less than 25 mm; and distance 150 may be between 50 mm and 250 mm.

The pocket has a multiplicity of channels 32 (FIGS. 3-4), which are configured so as to allow the blades to pass through them. The spacing of these channels along the length of the sprocket helps define the width of the roll that is produced. The spacing is equal to the length of the walls 76 and 78 and the curve portion 77 and may be between 50 mm and 360 mm. For rolls of wet wipes, the length may be about 95 mm.

It is preferred that the channels are narrow enough to provide sufficient support for the substrate, yet wide enough to allow the blade to pass through and to allow for thorough cleaning of the sprocket. For example, if the thickness of the blade is 0.157 inch (4.0 mm), the width of each channel may be ⅜ inch (9.5 mm). The channels may have other dimensions. A single log may be supported by a singular pocket 14 which contains channels 32 as grooves in the pocket. Alternatively, a single log or roll may be supported by a plurality of pockets in a linear arrangement. In this embodiment, the lateral spacing of these pockets from each other serves to form the channels, and the pockets in the linear arrangement form a pocket assembly. The sprocket itself may have grooves which contribute to the channel, and such a sprocket can be used with singular pockets or with pocket assemblies. The sprocket is preferably made of 316L stainless steel, and the pockets are preferably made of 907 cast nylon. Preferably, the sprocket comprise 8 singular pockets, equally spaced 45-degrees from each other. The distance from the centers of the radius of curvature 144 of two pockets separated by 180-degrees is preferably about 840 mm.

Any type of cutting device or saw may be used to cut the roll or log. For example, a band saw or knife blades may be used. A water jet cutting apparatus, such as is available from FLOW INTERNATIONAL, Seattle, Wash., may be used. Circular saw blades are presently preferred, and a diameter of 20-24 inches (508-610 mm) provides for complete cuffing of a log having a diameter of 73 mm while ensuring clearance of the blade shaft. Blades useful in this embodiment include those available from ORBITAL SAW CO, INC. The model 412034 is a nickel plated blade made of D-2 high-chrome tool steel, with a 24 inch (610 mm) diameter, 3.25 inch (82.6 mm) inner diameter (ID) bore, and a 0.150 inch (3.81 mm) thickness. Cutting devices of different sizes and/or configurations may be employed for different substrates.

In an embodiment of the invention, the saw 8 comprises a plurality of circular blades 16 and is mounted on a frame 2. The number of blades depends on the number of individual rolls 22 desired and is greater than the number of rolls. These blades can be mounted separately, or can be mounted on one common shaft, or can be mounted in discrete sections on more than one common shaft. The blades can be operated independently, or can be operated in at least one group. The blades can be mounted on at least one common shaft 54 and can be operated by one common motor. In an embodiment of the invention, half the blades are mounted on one common shaft 42, and half the blades are on another common shaft 44. These shafts can be operated by one common motor or can be connected to separate motors 85 and 86.

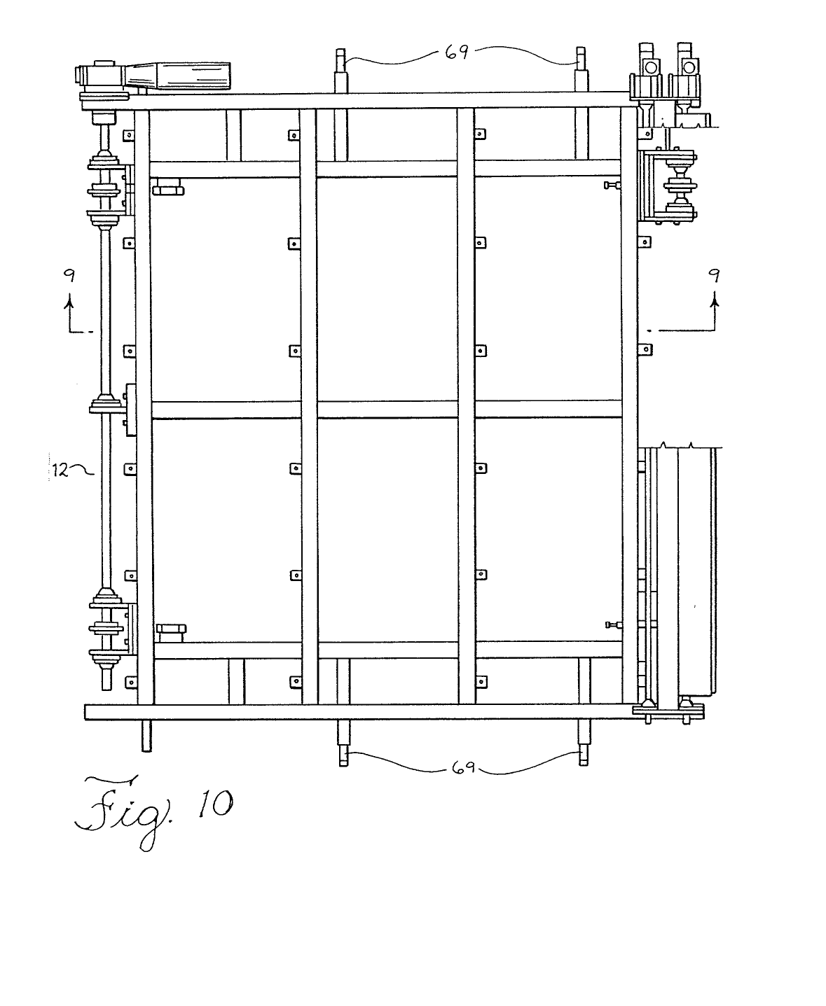

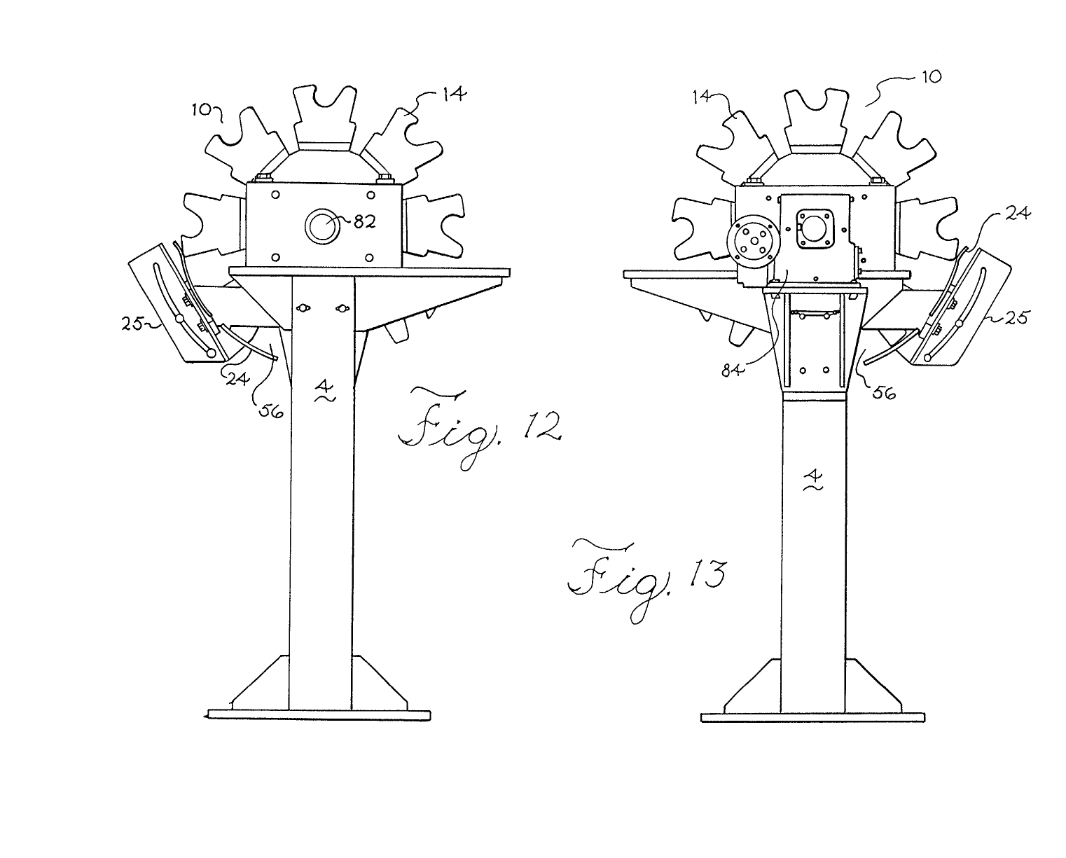

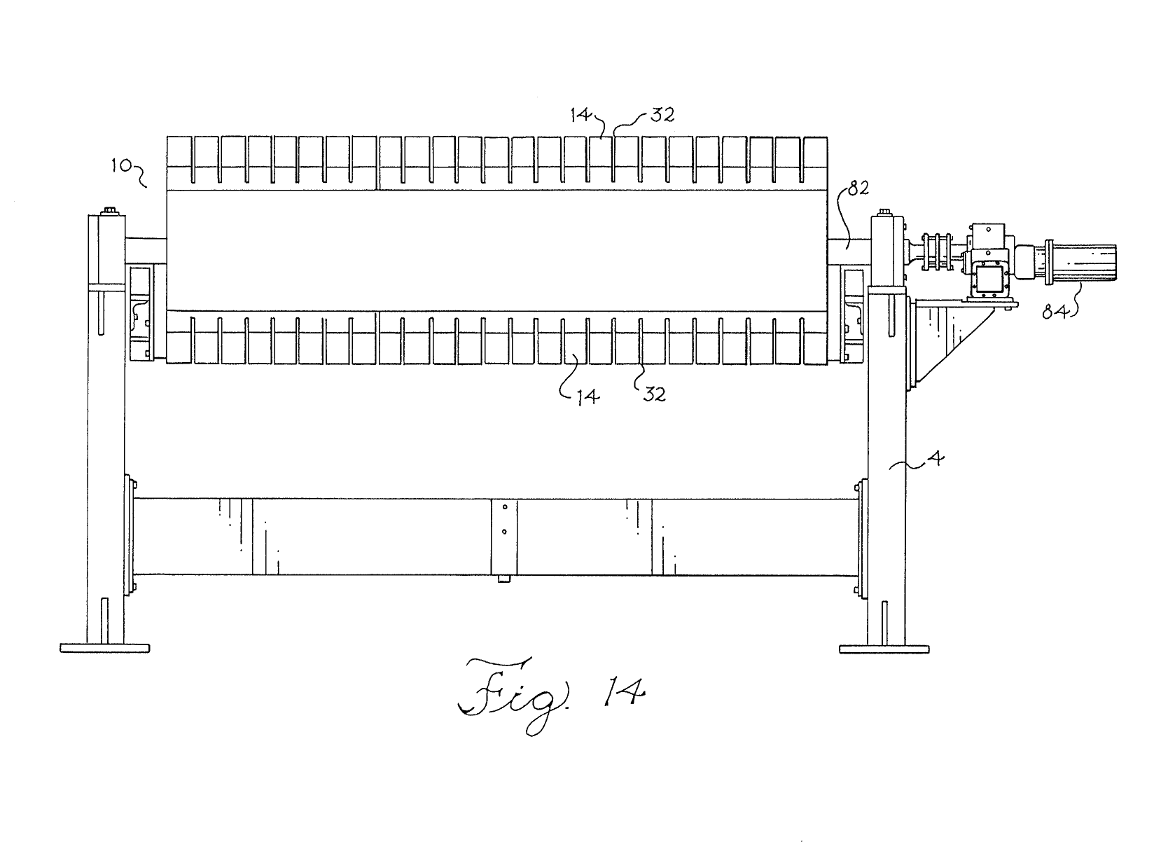

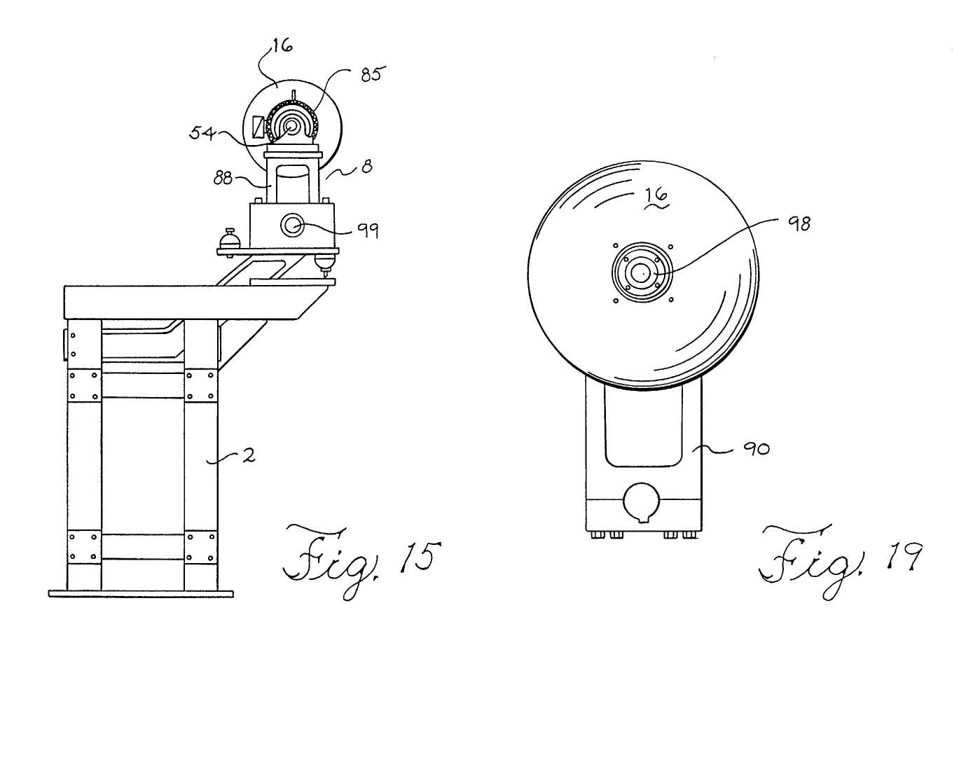

In the embodiments shown in FIGS. 15-25, 26 total blades, 13 each on shafts 42 and 44, form two cutting assemblies. These two assemblies together can produce 25 rolls of the desired dimensions from one log. For an individual assembly (FIG. 17), a shaft is mounted on a pair of pivoting support arms 88 and 90. All of the blades but one are mounted between these arms, with the remaining blade mounted on the interior end 94 of the assembly, the motor being connected to the exterior end 92 of the assembly. The support arms are pivotably mounted to the frame 2 by a pivot shaft 99. The distance between the centers of the blade shaft and the pivot shaft is 24 inches (0.6 m). The spacing between the blades is 4.125 inches (10.5 cm).

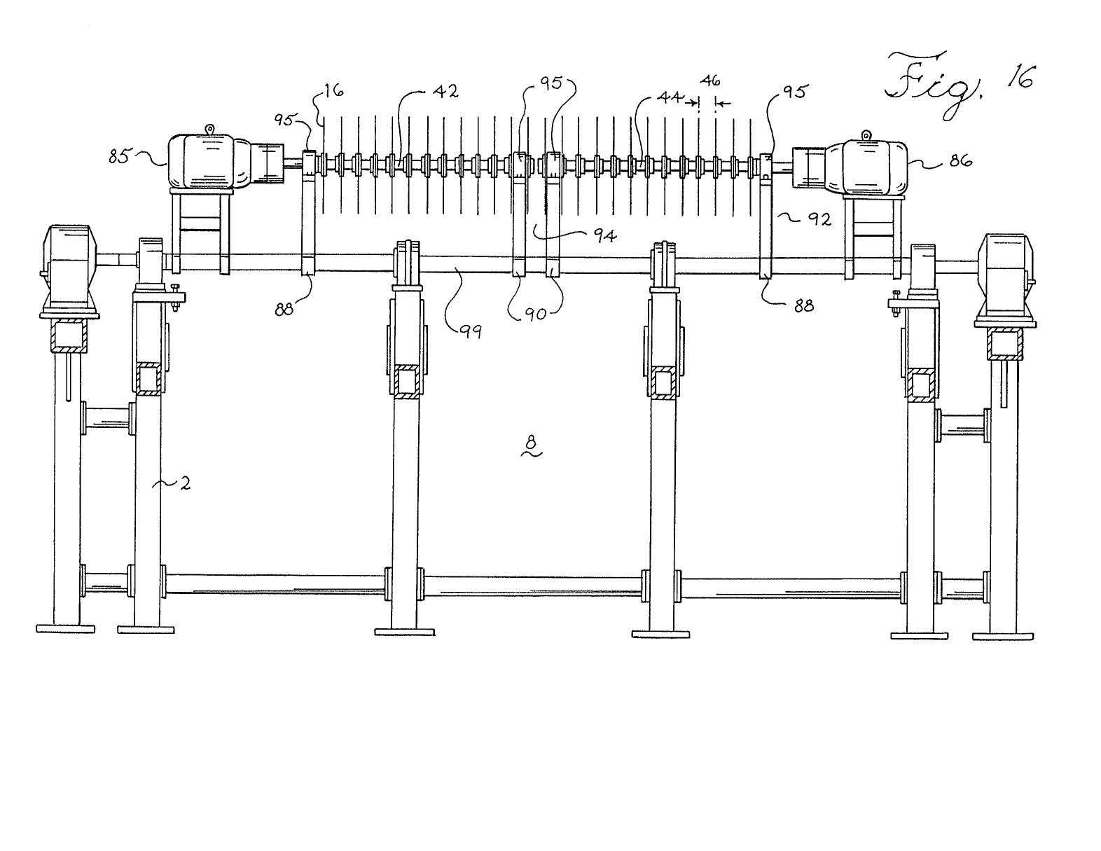

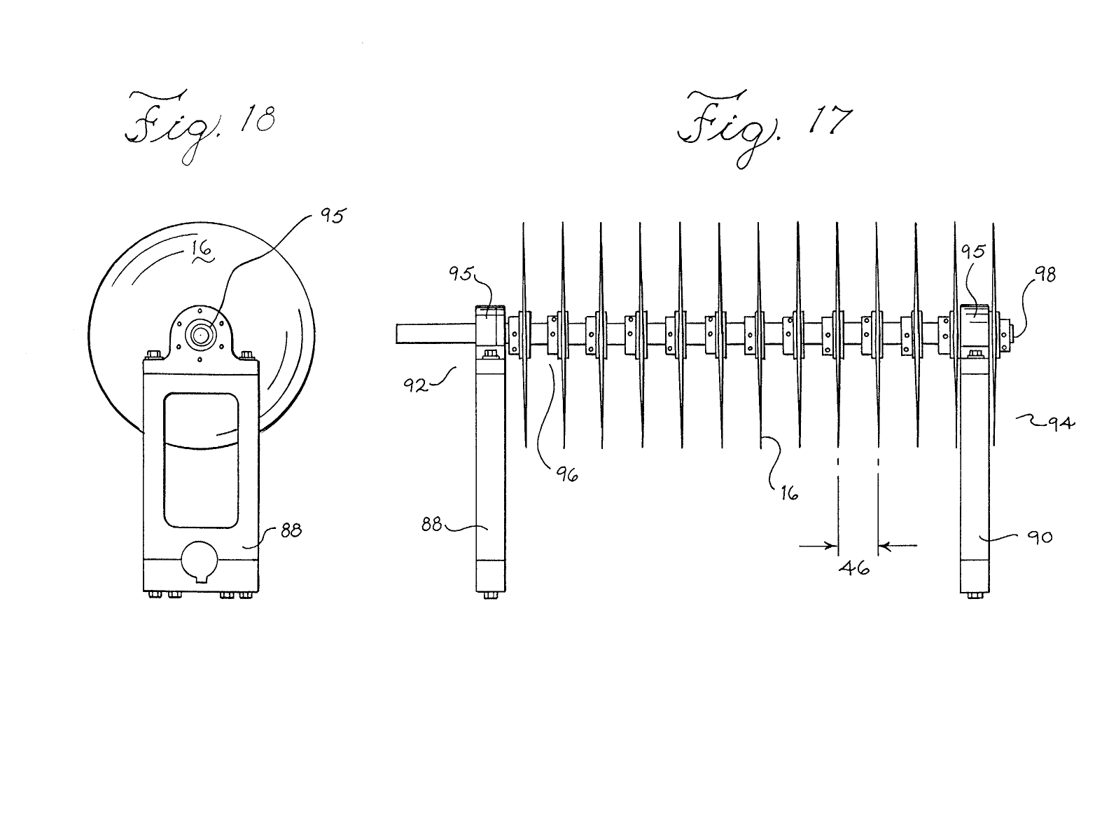

The shaft rotates inside a bearing mounting 95 on each support arm. The bearing mounting 95 has a housing 91 which is removably attached to a support arm, and the blade shaft moves over the bearings 93. The blades are removably mounted to the shaft by couplings 96 (FIGS. 22-23), or by coupling 98 for the blade at the interior end (FIGS. 24-25). The blades can be removed from the couplings by loosening the screws 97 on the coupling. This allows the blades to be serviced, inspected, or replaced. The blades on the shaft can be accessed by separating the bearing mounting on the interior end from the support arm 90, the shaft being secured by support arm 88. The blades are removed from the couplings and then removed from the shaft. The new blades are then installed into the couplings. Alternatively, the blade and the coupling together can be removed from the shaft before the blade is replaced. The coupling can then be fitted with a new blade, and the blade and coupling together can be mounted onto the shaft. Once the blade replacement is complete, the bearing housing can be re-secured to the support arm.

The spacing 46 of the blades relative to each other determines the size of the individual rolls produced. It follows that the consistency of this spacing affects the consistency of the product. Also, the spacing and configuration of the blades relative to the dimensions of the log affects the amount of waste produced by cutting the log. If the log is longer than the end-to-end distance of the array of blades, one or both ends may produce rolls which are too small to be of commercial value. The ends, or cookies, are waste material and are generally disposed of. It is desirable to reduce the size of these cookies, or to eliminate them if possible, so as to reduce the overall waste of the production. To the extent that the cookies are not eliminated, it may be necessary to remove them from the apparatus such as by way of a chute 70 (FIG. 5). This chute may deliver the cookies directly to a container for discarding or recycling, or the chute may deliver the cookies to a conveyor which removes them from the apparatus. For the wet wipes logs described above, the cookies preferably have a width of 1.5 inches (38 mm) or smaller.

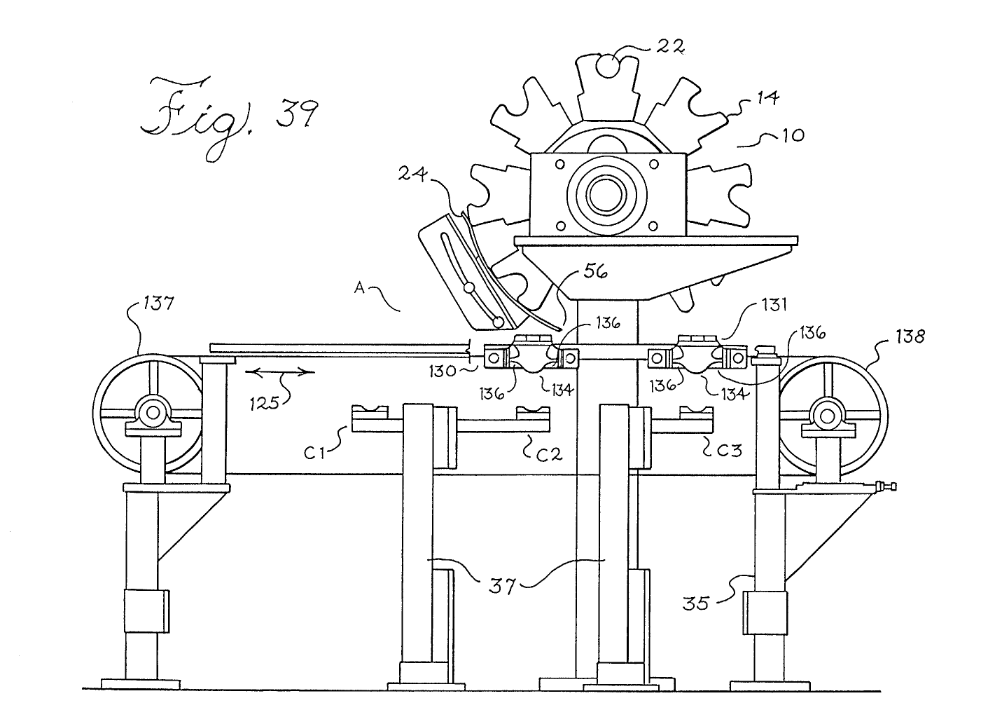

The blades can divide the log in a variety of ways. The saw 8 can remain in the down position 38 such that the blades are in the cutting area 80, and the log can be rotated into the blade. Also, the log can be held stationary for a period of time, and the saw can be moved through the log. FIGS. 36-38 illustrate an embodiment in which the blades oscillate between a raised position 120 and a lowered position 122. In the raised position 120, the support arm is about 10-degrees above the horizontal axis 126. In the lowered position 122, the support arm is about 7-degrees below the horizontal. This lowered position corresponds to having the blades in the cutting area. In this embodiment, the sprocket moves in a continuous manner. The blades are lowered and contact the log when the log is between 5 and 10-degrees from the vertical axis 128. The raised and lowered positions may have different angles of displacement. For example, the raised position 120 may be between 5-degrees and 30-degrees above the horizontal axis 126; and the lowered position 122 may be between 5-degrees and 15 -degrees below the horizontal axis 126.

Although it is possible that two logs could be in contact with the blades at one time, it is preferred that the blade is in contact with only one log during a cutting cycle. Once the log has been completely divided, the saw 8 is raised out of the cutting area. Depending on the speed of the sprocket, the log can have different positions at the time the blades are removed from the cutting area. It is preferred that the cutting is complete and the blades are removed by the time the log is centered on the vertical axis. It is preferred that the blades operate at a variable speed between 1500 rpm and 1700 rpm. The use of variable speeds is known to those in the art as a method to minimize vibrations in the apparatus.

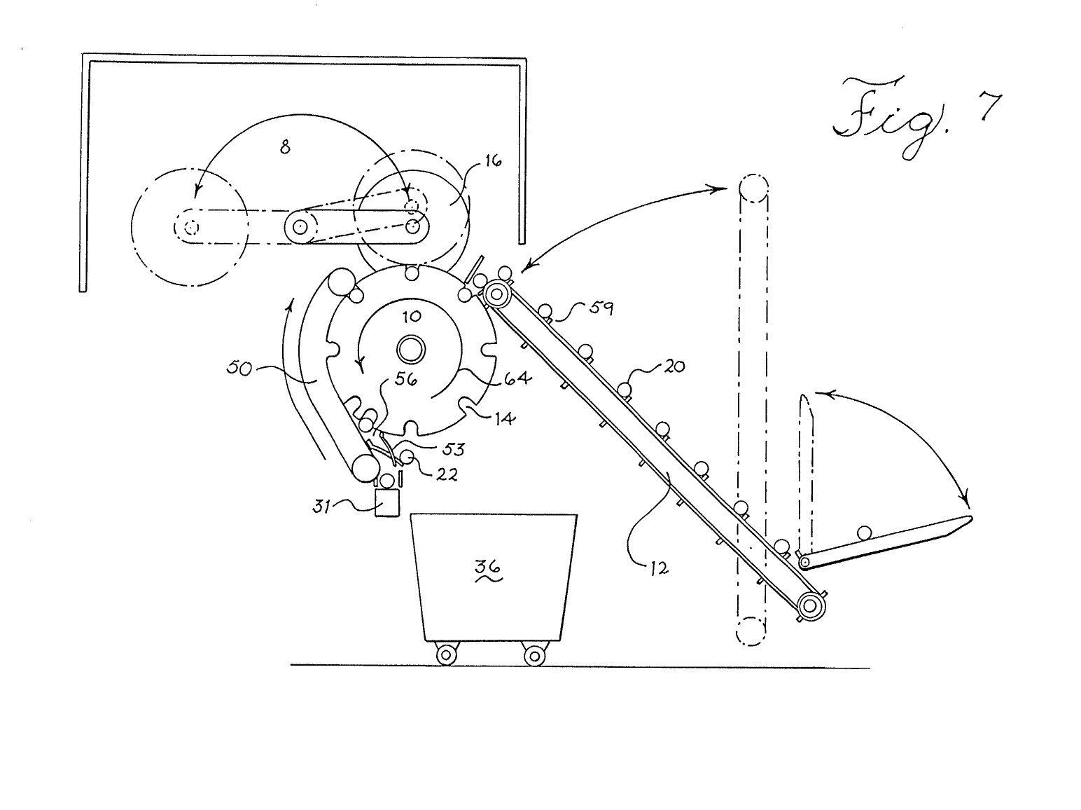

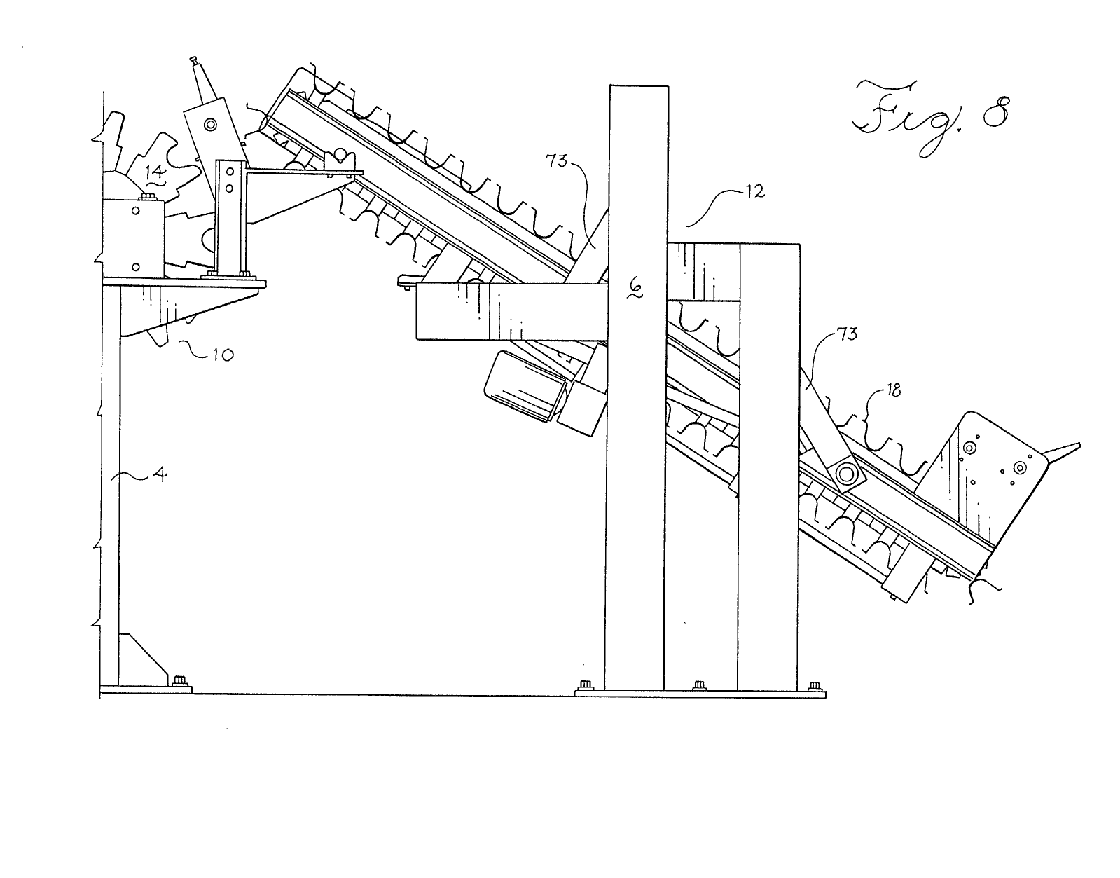

Preferably the saw blades 16 rotate in the direction opposite that of the sprocket as shown in FIG. 2. FIG. 11 shows a diagram of the forces exerted on a log during the cutting process, along with an illustration of the vector sum of those forces. The forces are represented as arrows or vectors having both a direction, which indicates the overall direction of the force, as well as a length, which indicates the relative magnitude of the force. The force F_{Tot} is the total force due to the blade, and is the sum of the forces due to the blade impacting the log F_{Imp} and due to the friction between the blades and the log and/or divided rolls F_{Bld}. This can be expressed mathematically as

F_{Tot}=F_{Imp}+F_{Bld}.

The force W is the force of gravity on the log, thus the vector points down. The force F_{Cen} is the centrifugal force due to the angular momentum of the log. The force F_{Pct} is the reaction force exerted by the pocket against these forces. For the log or roll to remain in the pocket, the net force on the substrate must be zero. This is expressed mathematically as

F_{Tot}+F_{Cen}+F_{Pct}+W=0.

This relation can be illustrated by the head-to-tail arrangement of the vectors in FIG. 11. Since the vectors form a complete cycle, there is no net vector that can be drawn from a tail to a head. Any vector that could be drawn would indicate a net force, and this force would result in motion of the log.

The shape of the pocket as shown in FIGS. 4, 11 and 36-38 helps to maintain a zero net force on the substrate by providing an effective reaction force, especially against F_{Tot}. The force F_{Tot} of the blade in the direction of arrow 66 pushes the substrate into the shorter of the two planar walls 78 of the pocket, and this wall exerts an equal and opposite reaction force. Without this wall, the substrate could be forced out of the pocket by F_{Tot}. The removal of the saw blades after the cut eliminates F_{Tot}. The pocket reaction force F_{Pct} thus only acts to counterbalance the force of gravity and any centrifugal force. Since F_{Bld} is dependent on a wide variety of factors, including surface characteristics of the blade, lubricating additives, substrate composition, and relative speeds of operation, it is possible to reduce F_{Bld}, and thus F_{Tot}, such that removal of the blades from the cutting area is not necessary. It is presently preferred that the blades are removed from the cutting area before the substrate is centered on the vertical axis.

The shape of the pocket and the action of the saw blades eliminate the need to clamp the roll to the sprocket. Deformation of the substrate can occur if clamps, skates, or other devices are used to substantially close the opening of the pocket during the cutting procedure. Use of these devices also provides increased difficulties in the maintenance and cleaning of the apparatus as a whole. The shape of the pocket also provides for support of the divided roll after the cutting procedure. The angled configuration prevents the roll from rotating out of the pocket until the substrate is centered at an angle of about 10-degrees below the vertical axis 128. Thus, the shape of the pocket provides for the substrate to be dropped into the pocket, secured through the cutting procedure, supported after cutting, and delivered to an exit point.

After the log is cut into individual rolls, the individual rolls are dispensed from the sprocket. This dispensing can take the form of allowing the roll to fall from the pocket. The sprocket and/or pocket can be equipped with a movable finger 48 (FIG. 2) to eject the rolls from the pocket, for example in a substantially horizontal motion. If the rolls are allowed to fall from the pocket, it may be desirable to prevent this dispensing until the roll has been rotated to an exit point 56. This can be accomplished by methods known to those skilled in the art. For example, a belt 50 or series of belts can be used (FIGS. 5 and 7) to cover the openings of the pockets until the exit point is reached. In the embodiment shown in FIG. 1, a shoe or plate 24 may be used. The dimensions of the belt or shoe necessary to control the dispensing can vary by the type of substrate and the shape of the pockets. The belt or shoe may be connected to the frame by a mounting bracket 25. In any of these embodiments, an exit dead plate 52 (FIG. 5) may also be employed to guide the dispensed roll to the desired location. A pivoting exit plate 53 (FIG. 7) may be used to direct the rolls to two or more different locations.

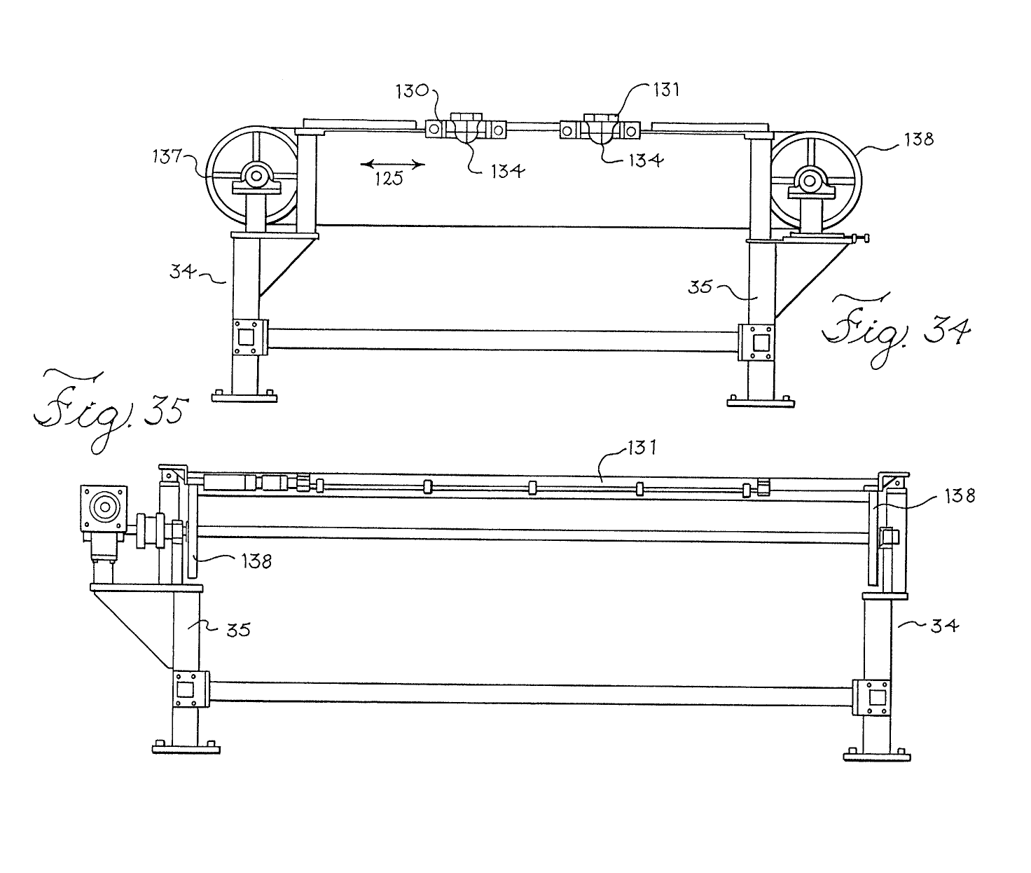

A diverter 34 may be employed to facilitate the transport of rolls away from the apparatus from a single exit point, or discharge location. Examples of diverters are illustrated in FIGS. 1, 6, 33-35, and 39-40. The diverter is located between the sprocket 10 and the index conveyors 33 and moves in the direction of arrow 125. The diverter comprises two receivers 130 and 131, each receiver having a pair of concave doors 134. The curved shape of the receivers assists in minimizing distortion of the rolls of product. The diverter is mounted on a frame 35 and is moved by a drive pulley 137 and an idler pulley 138. The receivers and the frame are made of 316L stainless steel, the drive pulley is made of AISI 4150 steel (electroless nickel coated), and the idler pulley is made of poly(ethylene terephthalate) (PET), specifically Ertalyte PET-P.

One receiver can hold an entire group of rolls formed from a single log. The diverter slides horizontally to a delivery position above one of the index conveyors and then opens its doors to deposit the rolls onto the conveyor. The conveyor can be in motion or can be stationary. It is presently preferred that the conveyor is stationary as the rolls are deposited and then moves the rolls a predetermined distance. The doors on the receiver are hingedly attached to the sides 136 of the receiver. The doors meet near the center, thus acting as “bombay” doors. The doors are operated with ALLEN BRADLEY servo motors and THOMSON MICRON gearboxes.

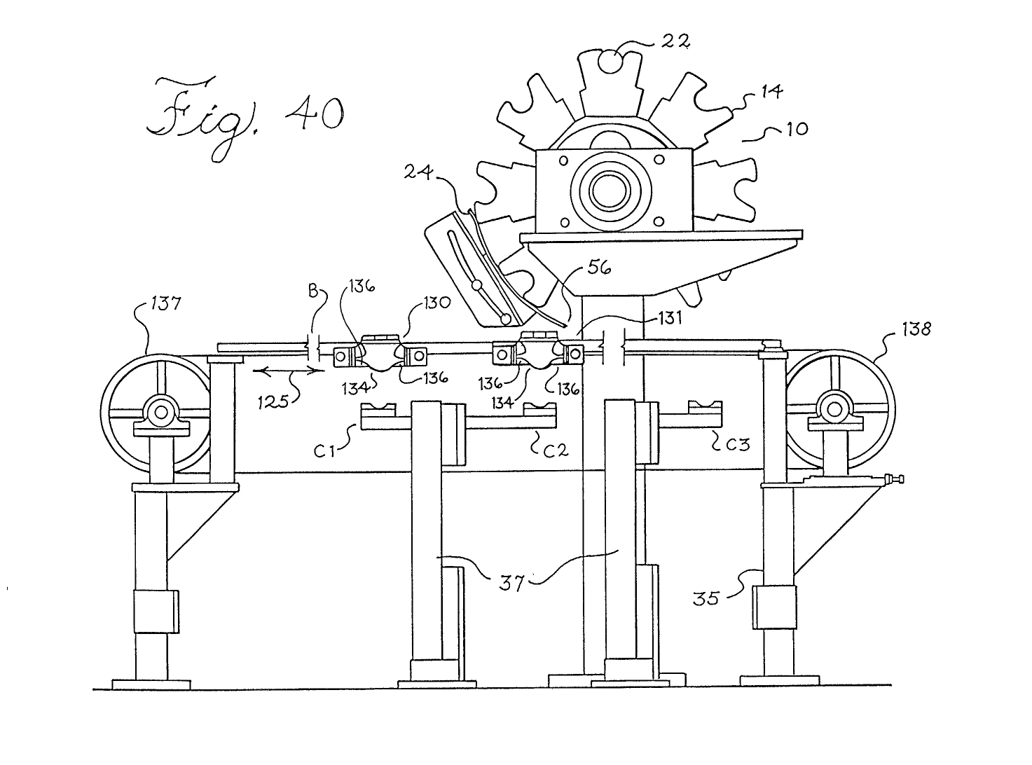

The index conveyors 33 travel in a direction perpendicular to arrow 125. The index conveyors may travel in other directions, but it is preferred that the portion of the index conveyor that is directly beneath the diverter is parallel to the receivers. The conveyors may be any kind of belt made of a corrosion resistant metal, plastic, or cloth. It is preferred that the conveyor belts are made of polyurethane that is molded to have a curved center as illustrated in FIGS. 39 and 40. This curved center helps to cradle the rolls that are dropped from the receiver so as to inhibit the rolls from bouncing and to keep them on the conveyor when they are indexed away from the machine. The index conveyors are mounted on a frame 37 of 316L stainless steel. The motion of the conveyor may be continuous or may be an indexing motion. It is presently preferred that a given index conveyor is stationary when the rolls are dropped onto it. The conveyor is then moved a specific distance to index the rolls away from the apparatus and to provide an empty section of the conveyor for the next group of rolls.

The spacing between receivers on the diverter is preferably the same as the spacing between the index conveyors. This configuration allows the one receiver to be loaded with rolls at the same time that the other receiver is depositing rolls onto an index conveyor. This simultaneous action provides for a lower acceptable sliding speed than would be required if a single receiver processed each set of rolls. The speed of the sliding action of the diverter is dependent on factors including the speed of the log saw apparatus and the number of indexing conveyors. For an apparatus dividing one log every 1.8 seconds and employing two index conveyors, it is preferred that the diverter slide at a rate of 41.25 inches (1048 mm) per second. The action of the diverter, that is the timing of the loading, unloading, and sliding, can be adjusted to accommodate the conveyor configuration. Tables 1-4 provide examples of the steps carried out by the diverter for four different scenarios using three different index conveyors. FIG. 39 illustrates the diverter and index conveyors with the diverter in position A. FIG. 40 illustrates the diverter and index conveyors with the diverter in position B. The conveyors are labeled C1, C2, and C3 from left to right.

TABLE 1
Conveyors C1 and C2 Operating

| TASK | TIME (s) |
|---|---|
| Diverter in position A | |
| Load rolls into receiver 130 | 0.25 |
| Cycle diverter to position B | 1.50 |
| Load rolls into receiver 131 | 0.25 |
| Deposit rolls from 130 onto conveyor C1 | 0.25 |
| Deposit rolls from 131 onto conveyor C2 | |
| Cycle diverter to position A | 1.50 |
| Repeat steps | |

TABLE 2
Conveyors C1 and C3 Operating

| TASK | TIME (s) |
|---|---|
| Diverter in position A | |
| Load rolls into receiver 130 | 0.25 |
| Cycle diverter to position B | 1.50 |
| Load rolls into receiver 131 | 0.25 |
| Deposit rolls from 130 onto conveyor C1 | 0.25 |
| Cycle diverter to position A | 1.50 |
| Load rolls into receiver 130 | 0.25 |
| Deposit rolls from 131 onto conveyor C3 | 0.25 |
| Cycle diverter to position B | 1.50 |
| Load rolls into receiver 131 | 0.25 |
| Deposit rolls from 130 onto conveyor C1 | 0.25 |
| Repeat steps | |

TABLE 3
Conveyors C2 and C3 Operating

| TASK | TIME (s) |
|---|---|
| Diverter in position B | |
| Load rolls into receiver 131 | 0.25 |
| Cycle diverter to position A | 1.50 |
| Load rolls into receiver 130 | 0.25 |
| Deposit rolls from 130 onto conveyor C2 | 0.25 |
| Deposit rolls from 131 onto conveyor C3 | |
| Cycle diverter to position B | 1.50 |
| Load rolls into receiver 131 | 0.25 |
| Cycle diverter to position A | 1.50 |
| Deposit rolls from 130 onto conveyor C2 | 0.25 |
| Deposit rolls from 131 onto conveyor C3 | |
| Repeat steps | |

TABLE 4
Conveyors C1, C2 and C3 Operating

| TASK | TIME (s) |
|---|---|
| Diverter in position A | |
| Load rolls into receiver 130 | 0.25 |
| Cycle diverter to position B | 1.50 |
| Load rolls into receiver 131 | 0.25 |
| Deposit rolls from 130 onto conveyor C1 | 0.25 |
| Deposit rolls from 131 onto conveyor C2 | |
| Load rolls into receiver 131 | 0.25 |
| Cycle diverter to position A | 1.50 |
| Load rolls into receiver 130 | 0.25 |
| Deposit rolls from 131 onto conveyor C3 | 0.25 |
| Repeat steps | |

The motion of the infeed conveyor and the distribution sprocket may be coordinated by methods known to those skilled in the art. For example, a programmable logic control (PLC) system such as manufactured by ALLEN BRADLEY can be used to coordinate any combination of the infeed conveyor, the distribution sprocket, the saw blades, the diverter, the index conveyors, and the metering gates. It is desirable that the total speed of the apparatus is sufficiently fast to provide for efficient mass production of the final product. The rate of distribution is preferably at least 300 rolls per minute, more preferably at least 700 rolls per minute. Higher or lower speeds may be optimal for different substrates.

The saw 8 may be configured such that maintenance can be performed during operation or during a pause in operation. For example, the blades can be replaced or inspected when the saw is in the raised position 39 (FIG. 1). There can optionally be a shield 81 for the saw 8 (FIG. 6). This shield is rigidly mounted to the infeed conveyor and is moved away from the saw when the conveyor is transitioned into its raised position. In the embodiments shown in FIGS. 1 and 5, there is a honing position 40 located 180-degrees from the cutting area, or down position. In FIG. 6, the honing position 41 is slightly above the vertical axis. When necessary, the saw can be rotated to the honing position to improve the cutting performance of the saw. The saw blades preferably have razor edges, that is there are not discrete teeth on the perimeter of the blades.

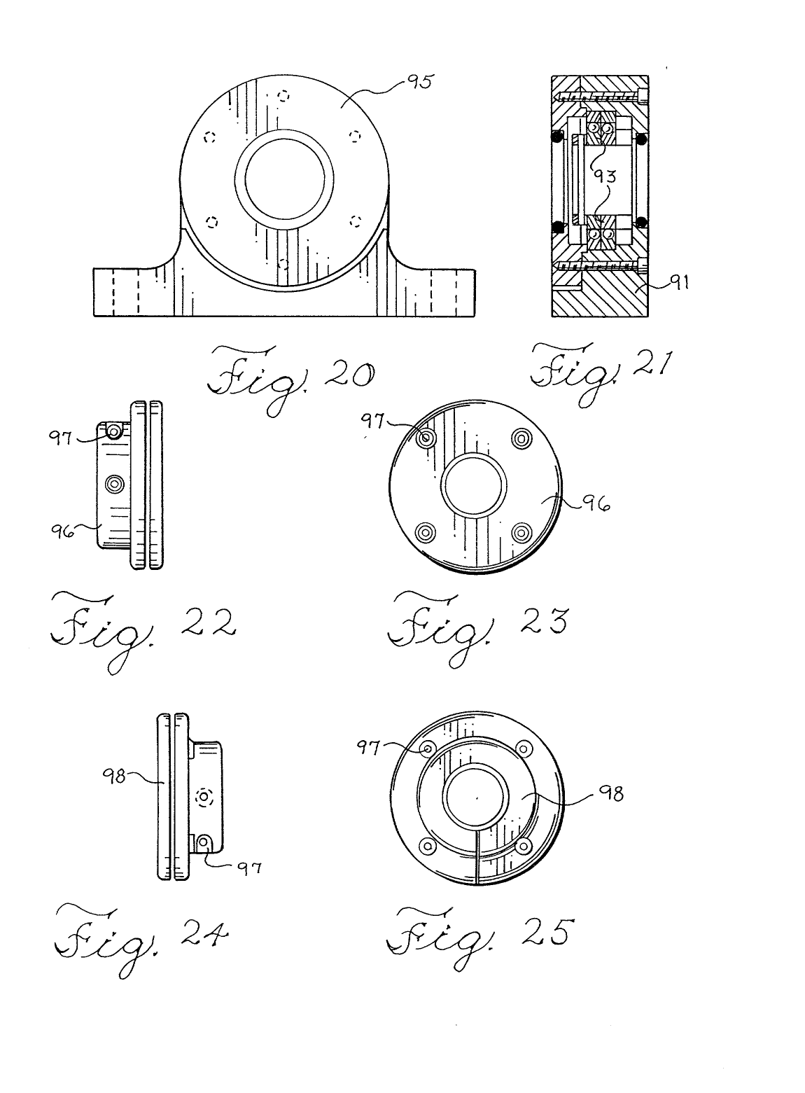

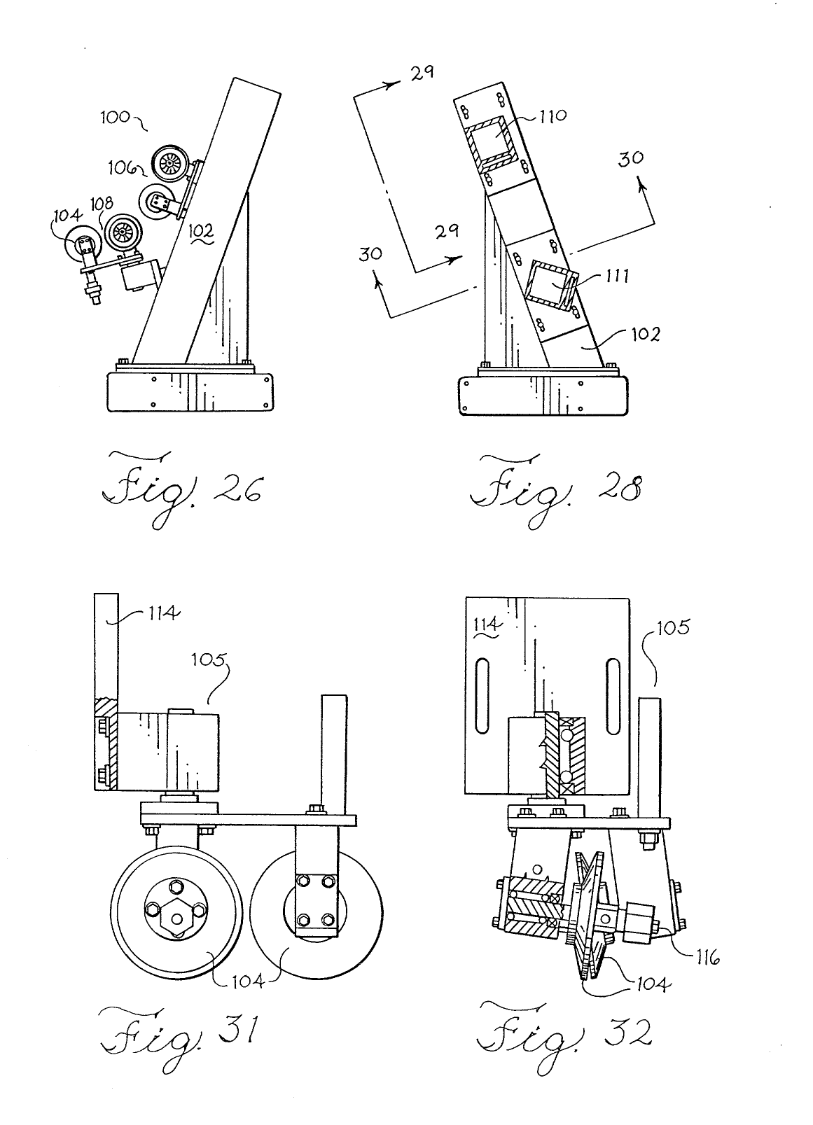

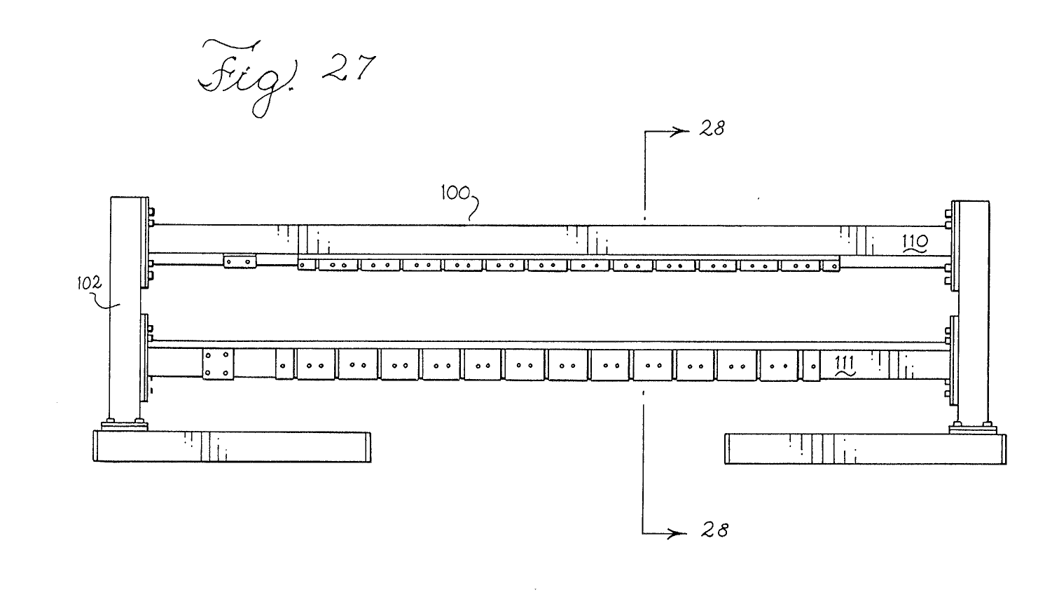

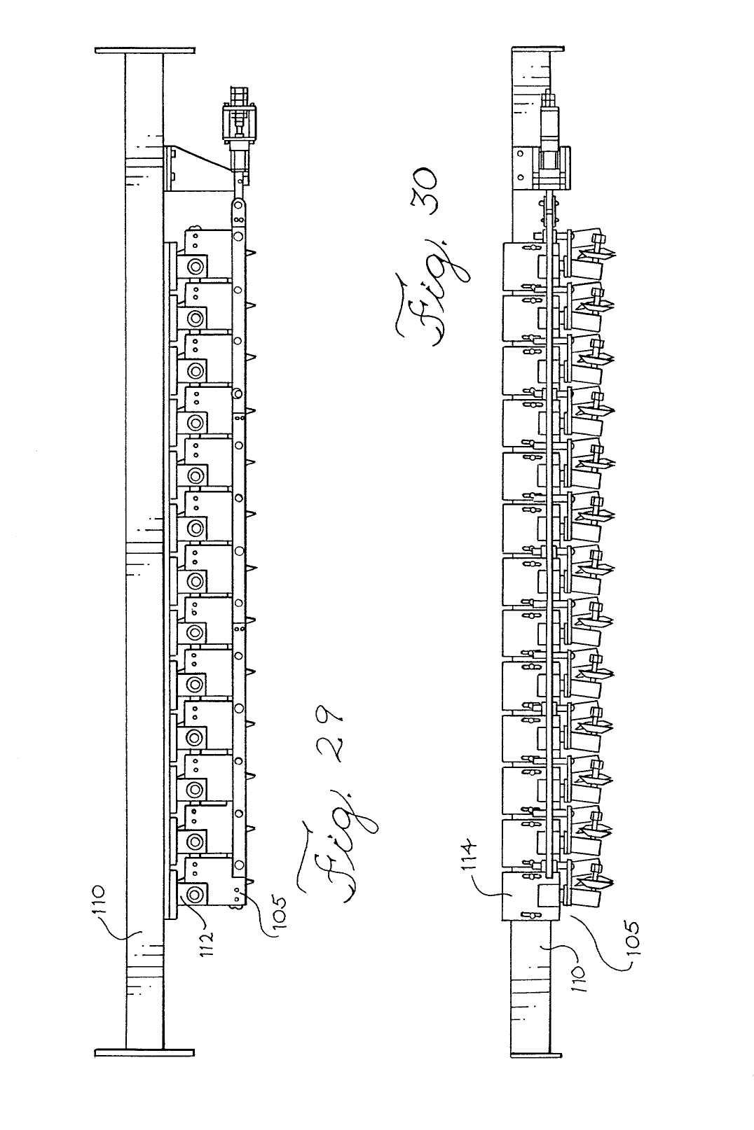

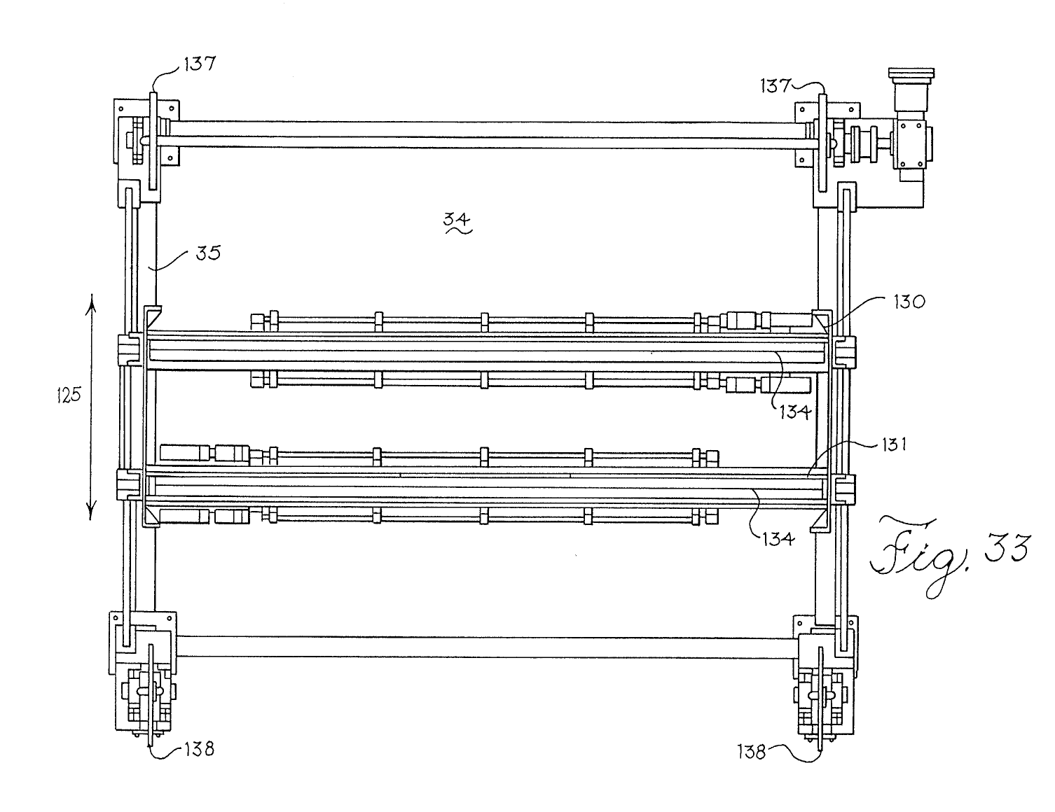

As illustrated in FIGS. 26-30, the honing assembly 100 can be mounted on a frame 102. The honing assembly comprises a honing unit 105 for each blade, each unit containing two honing wheels 104. An example of honing wheels which are useful for this apparatus are the RD82-HP-6608 from DESSAU INTERNATIONAL. In the embodiment shown in FIG. 26, there is one honing unit for each blade, and each honing wheel 104 is configured to contact the blade at a specific angle relative to the plane of the blade. For example, the honing wheels may contact the blade at an angle of 7-degrees. This results in an angle between the two wheels, and thus an angle at the blade edge, of 14-degrees. The clearance between the perimeter of a honing wheel and the blade is preferably 0.0625 inch (1.59 mm) so as to provide contact at only one point. In the embodiment shown in FIG. 26, the honing units are staggered. That is, the upper units 106 are offset relative to the lower units 108. This is preferred for this embodiment since the width of a honing unit is greater than the spacing between the blades 46. The upper and lower units are mounted on separate horizontal bars 110 and 111 by a clamp 112. Each pair of honing wheels is movably attached to the clamp by a linear slide 114. The position of each honing unit can thus be adjusted to the position and diameter of the blade with which it interacts. The force between the blade and the honing wheels can be controlled through a precision adjustment made with a micrometer thimble mechanism 116. The position of the honing wheels and their interaction force with a blade can be adjusted throughout the life of the blade.

The hones may be rotated by a motor, and the pair of hones for each blade can operate independently or can be operated collectively. Preferably the hones rotate freely, and the blades are rotated when in contact with the hones. For example, the blades can be pivoted close to the honing position and then pivoted in and out of the honing position to make contact with the honing units. A single honing procedure preferably includes multiple contacts between the blade and the hones to avoid overheating the blades. The blades may be operated at a speed similar to the cutting speed, or they may operate at a higher or lower speed.

The method of transporting, cutting, and handling substrates provided for by the described apparatus enables the cutting of low rigidity substrate logs, such as moistened logs, into individual rolls. Distortion of the finished product, especially in terms of shape and cut squareness, is minimized. When processing moistened product, this apparatus provides a sanitary processing environment due to its reduced potential for microbial growth. All components of this apparatus are preferably constructed from materials which are resistant to corrosion.

1. A continuous method of cutting a plurality of moist substrates comprising:
a) placing a log of moist substrate on a conveyor, the log having a length, a width and a moisture content of at least about 50%;
b) advancing the conveyor;
c) discharging the log from the conveyor onto a transfer plate;
d) placing the log into a pocket on a cutting support;
e) advancing the pocket containing the log toward a plurality of cutting blades;
f) advancing the pocket containing the log through the cutting blades, whereby the log is cut into a number of shorter rolls;
g) advancing the pocket containing the rolls away from the cutting blades;
h) discharging the rolls from the pocket; and,
repeating steps a) through h) in a continuous manner.

2. The method of claim 1, wherein the log is at least 2540 mm long.

3. The method of claim 1, wherein the log has a diameter of from about 50 mm to about 140 mm.

4. The method of claim 1, wherein at least 95% of the log is cut into useable rolls.

5. A method of cutting a coreless wet wipes log comprising:
a) placing a coreless wet wipes log in a pocket, the log having a length of at least 2540 mm, a diameter of from about 50 mm to about 140 mm and a moisture content of at least 50%;
b) advancing the pocket containing the log toward a cutting position;
c) cutting the log into a plurality of rolls in the cutting position;
d) the pocket maintaining the shape, integrity and position of the log as it is cut into rolls without the need for clamps and with out the need for a mandrel; and,
e) discharging the rolls from the pocket.

6. The method of claim 5, wherein steps a) through e) are repeated in a continuous process resulting in the production of at least 300 rolls per minute.

7. The method of claim 5, wherein a conveyor is used to place the logs in the pockets.

8. The method of claim 5, wherein the rolls are discharged into a diverter.

9. The method of claim 5, wherein at least 95% of the log is cut into useable rolls.

10. A method of making a plurality of wet wipes rolls comprising:
a) placing a wet wipes log on a conveyor, the log having a length, a width and a moisture content of at least about 65%;
b) advancing the conveyor;
c) discharging the log from the conveyor into a holding support;
d) advancing the support containing the log toward a plurality of cutting blades;
e) engaging the log and the cutting blades, whereby the log is sectioned into a plurality of rolls; and, repeating steps a) through e) so that at least 300 rolls are produced per minute.

11. The method of claim 10, wherein the log is at least 2540 mm long.

12. The method of claim 10, wherein the log has a diameter of from about 50 mm to about 250 mm.

13. The method of claim 10, wherein at least 95% of the log is cut into useable rolls.

14. A continuous method of cutting a plurality of wet wipes logs comprising:
a) placing a coreless wet wipes log on a conveyor, the log having a length, a width and a moisture content of at least about 50%;
b) advancing the conveyor;
c) discharging the log from the conveyor onto a transfer plate;
d) metering the rate at which the log is discharged from the transfer plate to a pocket;
e) advancing the pocket containing the log toward a plurality of cutting blades;
f) engaging the log in the pocket with the cutting blades, whereby the log is cut into a number of shorter rolls;
g) discharging the rolls from the pocket;
h) repeating steps a) through g) in a continuous manner; and,
periodically interrupting the repetition of steps a) through g) to move the cutting blades to a position away from pocket; and,
honing the cutting blades while in the away position, whereby material from the honing does not contaminate the pocket, the log, or the rolls.

15. The method of claim 14, wherein the log is at least 2540 mm long.

16. The method of claim 14, wherein the log has a diameter of from about 50 mm to about 140 mm.

17. The method of claim 14, wherein at least 95% of the log is cut into useable rolls.

18. A cutting apparatus comprising:
a base; a plurality of pockets; a drive; and a saw;
the plurality of pockets arranged in an endless loop; the drive associated with the pockets; the saw associated with the pockets; the pockets having channels therein; the saw having a cutting surface; the cutting surface being capable of being positioned within a channel; the pockets having a front side, a bottom and a back side; the front side having a lip; and the back side having a flat surface.

19. The cutting apparatus of claim 18, wherein the saw comprises at least 10 blades.

20. The cutting apparatus of claim 18, comprising at least 4 pockets.

21. The cutting apparatus of claim 18, wherein the pockets have a distance between the front side and back side, the distance being from about 50 mm to about 250 mm.

22. A cutting apparatus comprising:
a base; a sprocket; a plurality of pockets spaced around the sprocket; a drive; and a saw;
the drive associated with the sprocket; the saw associated with the sprocket; the pockets having a plurality of channels therein; the saw having a plurality of blades; the blades capable of being positioned within the channels; the pockets having a front side, a bottom and a back side; the front side having an arcuate lip; the front side having an flat surface; the bottom side having an arcuate surface; and the back side having a flat surface; the front and bottom surface forming a support surface that maintains the shape and form of the object during cutting.

23. The cutting apparatus of claim 22, wherein the saw comprises at least 10 blades.

24. The cutting apparatus of claim 22, comprising at least 4 pockets.

25. The cutting apparatus of claim 22, wherein the width of the pockets is from about 50 mm to about 150 mm.

26. A system for making rolls of wipes, the system comprising:
a first metering device; a first transporting device; a second metering device; a second transporting device; a cutting device; a holding device; and a third transporting device;
the first metering device associated with the first transporting device; the second metering device associated with both the first transporting device and the second transporting device; the second transporting device associated with the holding device; the cutting device associated with the second transporting device; the third transporting device associated with the second transporting device;
the first metering device comprising a first controller and a first gate; the first transporting device comprising a first drive, a second controller, a base, a frame and a plurality of pockets; the second metering device comprising a third controller and a second gate; the third transporting device comprising a second drive, a fourth controller, a diverting device, and a holding device; and, the cutting device comprising a plurality of blades, a third drive, and a fifth controller.

27. The system of claim 26, wherein the controllers are the same.

28. The system of claim 26, comprising a master controller; the master controller associated with the controllers.

29. The system of claim 26, wherein the cuffing device comprises at least 10 stainless steel blades.

30. The system of claim 26, comprising a honing device associated with the cutting device.

31. A method of cutting a plurality of flexible substrates comprising:
a) placing a flexible log on a conveyor, the log having a length and a width;
b) advancing the conveyor;
c) discharging the log from the conveyor into a holding support;
d) advancing the support containing the log toward a plurality of cutting blades;
e) engaging the log and the cutting blades, whereby the log is sectioned into a plurality of rolls; and,
repeating steps a) through e) so that at least 300 rolls are produced per minute.

32. The method of claim 31, wherein the log is at least 2540 mm long.

33. The method of claim 31, wherein the log has a diameter of from about 50 mm to about 250 mm.

34. The method of claim 31, wherein at least 95% of the log is cut into useable rolls.

35. A continuous method of cutting a plurality of flexible logs comprising:
a) placing a flexible log on a conveyor, the log having a length and a width;
b) advancing the conveyor;
c) discharging the log from the conveyor onto a transfer plate;
d) metering the rate at which the log is discharged from the transfer plate to a pocket;
e) advancing the pocket containing the log toward a plurality of cutting blades;
f) engaging the log in the pocket with the cutting blades, whereby the log is cut into a number of shorter rolls;
g) discharging the rolls from the pocket;
h) repeating steps a) through g) in a continuous manner; and,
periodically interrupting the repetition of steps a) through g) to move the cutting blades to a position away from pocket; and,
honing the cutting blades while in the away position, whereby material from the honing does not contaminate the pocket, the log, or the rolls.

36. The method of claim 35, wherein the log is at least 2540 mm long.

37. The method of claim 35, wherein the log has a diameter of from about 50 mm to about 140 mm.

38. The method of claim 351 wherein at least 95% of the log is cut into useable rolls.

39. A continuous method of cutting a plurality of substrates comprising:
a) placing a log of substrate on a conveyor, the log having a length and a width;
b) advancing the conveyor;
c) discharging the log from the conveyor onto a transfer plate;
d) placing the log into a pocket on a cutting support;
e) rotating the pocket containing the log toward a plurality of circular cutting blades;
f) rotating the pocket containing the log through the circular cutting blades, whereby the log is cut into a number of shorter rolls;
g) rotating the pocket containing the rolls away from the cutting blades;
h) discharging the rolls from the pocket; and,
repeating steps a) through h) in a continuous manner.
